(19) United States
(12) Patent Application Publication
(10) Pub. No.: US 2026/0288613 A1
(43) Pub. Date: Sep. 24, 2026

(54) SYSTEM

(71) Applicant: SoftBank Group Corp., Tokyo (JP)

(72) Inventor: Kazuyoshi AKAKURA, Tokyo (JP)

(73) Assignee: SoftBank Group Corp., Tokyo (JP)

(21) Appl. No.: 19/558,531

(22) Filed: Mar. 6, 2026

(30) Foreign Application Priority Data
Mar. 19, 2025 (JP) 2025-044538

(51) Int. Cl. G06F 11/34; G06N 3/0475

(52) U.S. Cl. CPC G06F 11/3438; G06N 3/0475

(57) ABSTRACT

A system includes a processor that is configured to track activities of a user by using an information processing apparatus and collect data related to the activities of the user, transmit the collected data to a storage device via a communication means and store the collected data in the storage device, and create a prompt for instructing a generative AI model to generate an activity history based on the stored data and input the prompt to the generative AI model.

### CROSS-REFERENCE TO RELATED APPLICATION

This application is based on and claims priority under 35 USC 119 from Japanese Patent Application No. 2025-044538 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for tracking and utilizing user activities performed through an information processing apparatus suffer from several problems. First, user activity data such as web browsing histories, application usage logs, and input operations are often stored in a fragmented manner across different devices and services, which prevents the user from obtaining a coherent and meaningful activity history. Second, even when sufficient activity data is accumulated, conventional systems merely display raw logs or simple chronological lists, which require the user to manually interpret and organize the information, imposing a significant cognitive burden. Third, existing systems do not effectively utilize generative AI models to derive higher-level insights or narrative-style activity histories from stored data. As a result, it is difficult for the user to understand past behavior patterns, reflect on specific dates or periods, or obtain automatically generated summaries and related information. The invention has been made in view of these circumstances, and an object of the invention is to provide a system that tracks user activities, reliably stores the resulting data, and uses a generative AI model to generate and provide an activity history and related information in a form that is easy for the user to review and utilize.

### SUMMARY

In order to achieve the above object, according to one aspect of the invention, there is provided a system comprising a processor, wherein the processor is configured to track activities of a user by using an information processing apparatus and collect data related to the activities of the user, transmit the collected data to a storage device via a communication means and store the collected data in the storage device, and create a prompt for instructing a generative AI model to generate an activity history based on the stored data and input the prompt to the generative AI model. According to another aspect of the invention, the processor is configured to use an extension function operating on the information processing apparatus to generate the prompt for instructing the generative AI model to generate the activity history and input the prompt to the generative AI model, thereby enabling flexible and detailed acquisition of activity data linked to the user's actual operation environment. According to still another aspect of the invention, the processor is configured to generate a prompt for instructing the generative AI model to extract related information in order to enable the user to review activities performed on a specific date or during a specific period by using the activity history, and input the prompt to the generative AI model, thereby allowing the user to obtain summarized or contextual information corresponding to particular dates or periods without manually searching raw logs. Through these means, the system effectively integrates activity tracking, data storage, and generative AI-based processing to provide an intelligible and useful activity history to the user.

The term “system” refers to an arrangement of one or more hardware and/or software components that cooperate to perform the processing described in the claims, including at least a processor and may further include memory, storage devices, communication interfaces, and an information processing apparatus.

The term “processor” refers to any hardware component or combination of hardware components capable of executing instructions, such as a central processing unit (CPU), a microprocessor, a digital signal processor, a graphics processing unit (GPU), a dedicated logic circuit, or a combination thereof.

The term “information processing apparatus” refers to any device capable of executing software and processing information, including but not limited to a personal computer, a smartphone, a tablet, a server, or another electronic device that can track and record user activities.

The term “user” refers to a person or entity that operates or interacts with the information processing apparatus, whose activities are tracked by the system.

The term “activity” refers to any interaction or operation performed by the user through the information processing apparatus, including, for example, web browsing, application usage, input operations, content viewing, or content creation.

The term “data related to the activities of the user” refers to information obtained by tracking the user's activities, including but not limited to timestamps, accessed resources, operation logs, URLs, content identifiers, metadata, and contextual information associated with the activities.

The term “communication means” refers to any hardware and/or software mechanism that enables data transmission between the information processing apparatus, the processor, and the storage device, including wired or wireless communication interfaces, network protocols, and communication modules.

The term “storage device” refers to any device or medium capable of storing data persistently or semi-persistently, such as a hard disk drive, a solid-state drive, a flash memory, an optical disk, a network-attached storage, or a cloud storage system.

The term “stored data” refers to the data related to the activities of the user that has been transmitted to and recorded in the storage device.

The term “generative AI model” refers to a machine learning model configured to generate outputs such as text, images, audio, or other data based on input data, including, for example, large language models, text generation models, or other generative models.

The term “prompt” refers to input data provided to the generative AI model that defines, specifies, or constrains the content, style, or purpose of the output to be generated by the generative AI model.

The term “activity history” refers to information generated by the generative AI model based on the stored data, the information describing, summarizing, or organizing the user's activities over time in a narrative, structured, or otherwise human-readable form.

The term “extension function” refers to a software component that operates on the information processing apparatus and extends the functionality of an existing application or environment, such as a browser extension, plug-in, add-on, or similar module, for the purpose of tracking activities or generating prompts.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

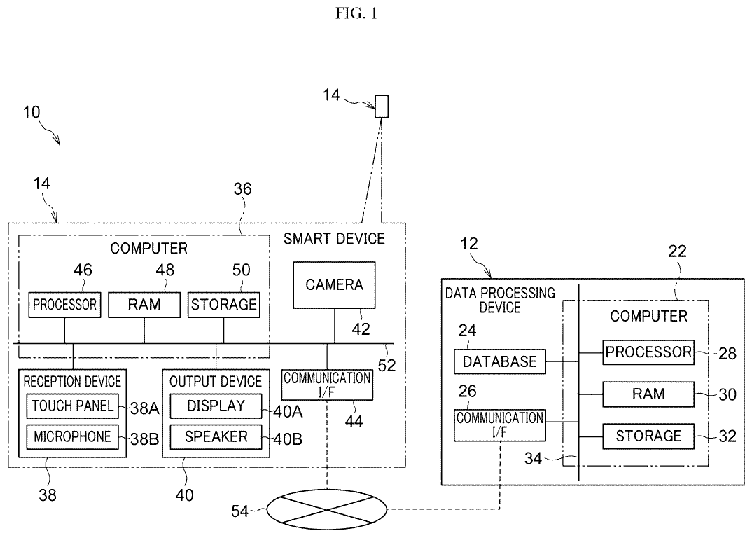

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

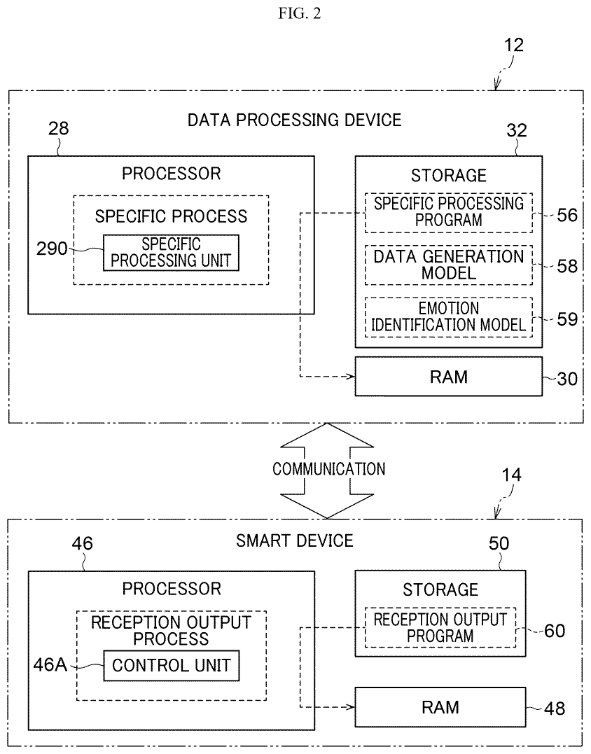

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for recording and reviewing user activity on network resources typically rely on simple logging mechanisms that store raw access records such as URLs and timestamps in a storage device. Such systems suffer from several technical problems from the standpoint of computer technology.

First, conventional logging mechanisms generally record activity in a flat, unstructured, and application-specific format. When a user later attempts to retrieve and review past activity, the server must execute multiple complex queries or application-level processing routines over large volumes of log data. This results in inefficient use of processor resources, increased memory consumption, and longer response times, particularly when the system must filter by date, time range, or content attributes. As the volume of stored activity data grows, these inefficiencies are exacerbated.

Second, known systems typically do not exploit generative information processing models in a way that is technically integrated with the logging pipeline. When generative models are used at all, they are often invoked manually, with ad hoc inputs constructed on the client side. As a result, the server cannot systematically reuse structured activity information, and cannot automatically generate compact summaries or organized histories that reduce the amount of data that needs to be transmitted and rendered. This leads to unnecessary network traffic and client-side processing overhead when large raw activity logs are presented to the user.

Third, existing systems often treat user queries as rigid, form-based requests requiring the user to specify exact filters or parameters. When a query is provided as a natural language sentence, conventional servers do not efficiently map such sentences to structured conditions and do not leverage generative models to perform server-side extraction and organization operations. Consequently, the server must either transmit large unfiltered datasets to the client or execute expensive, custom application code paths, which negatively affects scalability and overall system performance.

Fourth, typical browser-side extensions or scripts, when used, are limited to basic URL capture and do not perform structured extraction of content-related metadata such as titles or viewing duration in a normalized, time-series activity format. This lack of structured, time-aligned activity information prevents the server from optimizing how it aggregates, indexes, and feeds data into generative models, leading to duplicated computations and less efficient indexing strategies in the storage device.

Accordingly, there is a need for an improved computer-implemented technique that:
(1) structures user activity information at the time of acquisition in a time-series format suitable for efficient querying and model input,
(2) automatically generates prompt sentences that embed such structured activity information and instruct a generative information processing model to produce activity histories and summaries, and
(3) uses the output of the generative information processing model on the server side to generate history information in a presentation-ready format, thereby reducing server-side processing complexity, network traffic, and client-side rendering overhead, and improving the overall efficiency and scalability of the activity review system.

The specific processing by the specific processing unit 290 of the data processing device 12 in Example 1 is realized by the following means.

The present invention provides a server comprising a processor configured to monitor, by using a display control function operating on an information processing apparatus, browsing operations of a user with respect to an information resource and to acquire identification information and viewing time information relating to the information resource; to structure acquired identification information and viewing time information of the information resource as activity information in association with a time series and to transmit the activity information to a storage function via a communication function so that the activity information is accumulated in the storage function; to generate a prompt sentence based on the activity information accumulated in the storage function, the prompt sentence including at least a part of user identification information, time range information, attribute information of the information resource, and summary instruction information, to embed at least a part of the activity information into the prompt sentence, and to input the prompt sentence to a generative information processing model so as to instruct the generative information processing model to generate at least one of an activity history of the user and summary information relating to the activity history; and to acquire at least one of the activity history and the summary information output from the generative information processing model and to generate history information in a format capable of being presented to the user based on an acquired result. This enables the server to convert low-level, time-series activity logs into higher-level, structured histories and summaries on the server side with reduced computational overhead, to answer natural-language queries by efficiently leveraging generative models, and to improve overall system performance and scalability by minimizing the volume and complexity of data that must be transmitted to and processed by client-side components.

The term “information processing apparatus” refers to a hardware and software platform including at least one processor, a memory, a storage device, and an input/output interface, which executes programs to process data and control user interactions, such as a personal computer, a tablet device, or a smart device.

The term “display control function” refers to a software function or software module executed on the information processing apparatus that controls rendering of information resources on a display, including layout, drawing of user interface elements, and updating of displayed content in response to user operations.

The term “browsing operations” refers to user actions performed through an input device with respect to an information resource displayed on the information processing apparatus, including at least one of loading a page, following a link, scrolling, switching tabs, focusing or unfocusing a window, and closing a page.

The term “information resource” refers to a unit of content accessible via a communication network, including at least one of a web page, a document, a media item, or an application screen, which can be identified by identification information such as a uniform resource locator.

The term “identification information” refers to data that uniquely or quasi-uniquely specifies an information resource or a user, including at least one of a resource address, a resource identifier, a user identifier, or an account identifier.

The term “viewing time information” refers to temporal data indicating a period during which an information resource is presented to the user, including at least one of a start time, an end time, and a duration for which the information resource remains in an active viewing state.

The term “time series” refers to an ordered sequence of data elements, each associated with at least one temporal value, such that the elements can be processed or analyzed in chronological order.

The term “activity information” refers to structured data representing user behavior with respect to information resources over time, including at least identification information of the information resource, viewing time information, and optionally additional attributes such as a title, a category, or a referrer.

The term “communication function” refers to hardware and software components that enable the transmission and reception of data between the information processing apparatus and a remote device or server over a communication network, using a communication protocol such as a secure hypertext transfer protocol.

The term “storage function” refers to a hardware and software mechanism that persistently stores data, including at least one of a database system, a file system, and a storage controller, and that supports operations for writing, reading, and updating activity information.

The term “user identification information” refers to information that associates activity information with a particular user, including at least one of a user ID, an account ID, a session ID, or a pseudonymous identifier.

The term “time range information” refers to information specifying a temporal scope used to filter activity information, including at least one of a date, a time interval, a period, or a combination thereof.

The term “attribute information of the information resource” refers to metadata describing characteristics of the information resource, including at least one of a title, a content type, a category, a source domain, or a tag.

The term “summary instruction information” refers to information included in a prompt sentence that specifies how a generative information processing model should summarize or organize activity information, including at least one of a summarization level, a grouping criterion, or a focus topic.

The term “prompt sentence” refers to text or structured input provided to a generative information processing model, including instructions, constraints, and embedded activity information, which guides the model to generate at least one of an activity history and summary information.

The term “generative information processing model” refers to a machine-implemented model, such as a generative artificial intelligence model or a large language model, configured to receive a prompt sentence and to produce generated output including at least one of natural language text, structured data, or organized activity history.

The term “activity history” refers to an arrangement of activity information for a user in chronological or logical order, which represents a sequence of user interactions with information resources over a specified time range.

The term “summary information” refers to condensed information derived from activity information or an activity history, including at least one of a textual summary, topic grouping, highlight list, or statistical overview.

The term “history information” refers to data generated on the server side for presentation to the user, including at least one of an activity history, summary information, and related metadata formatted for display in a user interface.

The term “acquisition function” refers to a software function, module, or component that operates on the information processing apparatus to obtain structural information and metadata from an information resource and to output the obtained data as part of activity information.

The term “extension function” refers to an add-on or plugin software component that extends functionality of an application executing on the information processing apparatus, such as a browser extension that adds monitoring and data extraction capabilities.

The term “structural information” refers to data describing the internal organization of an information resource, including at least one of a document object structure, a markup tree, or layout metadata, which can be analyzed to extract identification information and title information.

The term “title information” refers to data indicating a title or label of an information resource, including at least one of a page title, a document heading, or a caption that represents the main subject of the information resource.

The term “viewing duration information” refers to data representing the length of time an information resource remains in an active viewing state for a user, typically computed from a start time and an end time associated with browsing operations.

The term “query sentence in natural language format” refers to a user-provided input expressed in a natural language, such as written text specifying a date, a period, or conditions for retrieving or summarizing activity information.

The term “condition for extracting activity information” refers to one or more constraints or rules incorporated into a prompt sentence that specify which subset of activity information is to be selected, including conditions based on date information, period information, resource attributes, or user identifiers.

The term “related information” refers to information output from the generative information processing model that has been extracted, filtered, or organized according to conditions defined in the prompt sentence, and that corresponds to at least a portion of the stored activity information.

In one embodiment, a server, a terminal, and a user cooperate to implement the claimed system. The server includes at least one processor, a main memory, a non-volatile storage device such as a solid-state drive, and a network interface. The terminal includes at least one processor, a memory, a display, an input device, and a network interface, and executes a web browser. The user operates the terminal to browse information resources over a communication network.

The terminal uses a browser application, such as a hypertext transfer protocol browser, and an extension function installed in the browser. The terminal uses the browser and the extension function as a display control function and an acquisition function. The terminal executes the extension function within a content rendering process of the browser and accesses a document object model of each information resource loaded into the browser. The terminal reads a resource address as identification information, a document title as title information, and rendering state information as structural information, from the document object model.

The terminal detects, by monitoring window focus events, tab activation events, and visibility change events, an interval during which an information resource is in an active viewing state. The terminal computes viewing time information and viewing duration information by recording a start timestamp when the information resource is activated and an end timestamp when the information resource is deactivated. The terminal associates the identification information, title information, viewing time information, and viewing duration information with user identification information obtained from a browser-side storage or cookie, to form activity information. The terminal structures the activity information as a time series, for example, by maintaining a sequence of records each containing a user identifier, a resource identifier, a start time, an end time, and a duration, and by ordering these records by the start time.

The terminal transmits the activity information to the server through a communication function. The terminal establishes a secure session using a secure transport protocol such as a transport layer security-based protocol over a packet network. The terminal encapsulates the activity information in request messages, and the terminal reduces communication overhead by grouping multiple activity records into a single message whenever a size threshold or time threshold is reached. The terminal thereby decreases the number of network round trips and reduces processing overhead at the server.

The server receives the activity information via the network interface and passes it to an application module. The server validates user identification information, normalizes timestamps to a unified time standard, and stores the activity information in a storage function. The storage function can be implemented by a relational database system such as a structured query language database running on the storage device. The server organizes the storage function so that each activity record is indexed by user identification information and by a compound index of start time and resource identifier. The server further maintains a derived index that aggregates viewing duration per resource per day. This data structure allows the server to answer temporal queries using a small number of index seeks and to prepare compact inputs for a generative AI model.

The server uses a generative AI model as a generative information processing model. In one embodiment, the server uses a transformer-based neural network including a plurality of encoder-decoder layers. The server configures each layer with multi-head self-attention, feed-forward sublayers, and layer normalization. The server represents each token of a prompt sentence as an embedding vector, and the server adds positional embeddings to preserve order information. The server trains the generative AI model in advance on a corpus that includes natural language descriptions of user activities and structured log summaries, by minimizing a cross-entropy loss between predicted tokens and ground-truth tokens. The server updates the model parameters, including attention weights and feed-forward weights, by using stochastic gradient descent or a variant thereof such as Adam optimization. The server performs training with mini-batches of sequences and applies dropout regularization and data augmentation, for example by paraphrasing activity descriptions and varying time expressions, to increase robustness to different query styles.

The server receives, from the terminal, a query sentence in natural language format provided by the user. The user enters, on a web application interface rendered by the terminal, a prompt sentence such as:
“Show my browsing history for 2023-10-01.”
or
“Using my browsing history from 2023-10-01, summarize what topics I mainly read about and group the pages by topic.”

The terminal transmits the prompt sentence to the server together with user identification information and optional structured parameters such as a start date and an end date. The server analyzes the prompt sentence using a natural language parsing module, such as a rule-based date recognizer and a shallow parser. The server extracts date information, period information, and optionally domain constraints, and the server constructs a query against the storage function. The server retrieves the subset of activity information corresponding to the extracted date or period. The server then converts the stored records into a compact textual representation designed for efficient processing by the generative AI model, for example:
“User: [user_id_123]
Date: 2023-10-01
1. 09:15-09:25, URL: [resource_1], Title: [title_1]
2. 09:30-09:40, URL: [resource_2], Title: [title_2]
3. 10:00-10:10, URL: [resource_3], Title: [title_3]. . .”

The server generates, as a prompt sentence to the generative AI model, a combination of an instruction part and a context part. For example, the server constructs a prompt sentence:

“You are a system that organizes a user's web browsing history. Based on the following list of pages the user viewed on 2023-10-01, generate a chronological activity history summarizing the user's actions, and also group the pages by main topic and provide a short description for each topic group. Use the list of URLs, titles, and viewing times given below.
[activity List Here]”

The server embeds at least a part of the activity information into the prompt sentence in this manner. The server supplies the prompt sentence to the generative AI model. The server sets model parameters such as a maximum output length and a sampling temperature. The generative AI model processes the prompt sentence by propagating the token embeddings through the transformer layers, applying self-attention to capture relationships between different activity entries and instruction tokens. The model computes attention scores that emphasize tokens corresponding to time expressions and topic keywords in titles, based on learned attention weights. As a result, the model produces output tokens that represent an activity history and summary information, including grouped topics and textual explanations.

The server receives the output token sequence from the generative AI model and converts it into text. The server parses the text to identify segments corresponding to a chronological history, topic groups, and per-topic lists of resources. The server then generates history information as structured data, which the server then renders into a presentation format such as hypertext markup that can be displayed on the terminal. The server includes both raw activity entries and model-generated summary segments in the history information. The terminal displays this history information to the user as an interactive interface, allowing the user to review the browsing activity on a specific date or over a period.

The server improves computer technology by structuring activity information at acquisition time and by integrating the structured data with the generative AI model in a way that reduces computational load and communication overhead. Because the terminal computes viewing duration using local event monitoring and transmits only structured, time-aligned activity records, the server does not need to reconstruct time ranges from low-level logs. This reduces server CPU cycles and decreases database input/output operations. Because the server embeds only relevant, filtered activity information into the prompt sentence and instructs the generative AI model to perform both summarization and grouping in one pass, the server avoids multiple rounds of query and post-processing that would otherwise be needed. This reduces latency and increases throughput, especially when many users submit natural language queries concurrently.

The server further improves data management by using indexes tailored to the prompt generation and model input processes. The server maintains a time-series index on the storage function that aligns with the way the generative AI model expects activity sequences. This alignment allows the server to fetch contiguous ranges of records in a small number of sequential reads, which is more efficient than random access patterns. The server thereby improves cache utilization in the storage subsystem and reduces response time for history generation.

The generative AI model, as used by the server, operates according to rules and procedures that differ from conventional human summarization. The model uses attention mechanisms to automatically weight different parts of the activity information according to relevance to the instruction contained in the prompt sentence. The server constrains the model by providing explicit grouping criteria or by including in the instruction part phrases such as “group by main topic and ignore pages with very short viewing duration.” The model then uses viewing duration values as features in its internal representation, effectively de-emphasizing brief, possibly accidental visits. This non-intuitive rule set, based on attention over duration features, enables more technically precise and consistent summaries than manual curation or simple keyword counts.

In another embodiment, the server uses a variant of the generative AI model that incorporates additional numerical features, such as viewing duration and frequency of visits, by concatenating them with token embeddings or by injecting them into side channels processed by separate dense layers. The server trains this variant using a loss function that combines language modeling loss with an auxiliary classification loss that predicts coarse-grained topics from activity lists. The server thereby encourages the model to learn a representation that simultaneously supports coherent text generation and accurate topic grouping. As a result, the generated summaries and groupings are not only linguistically fluent but also technically aligned with the stored activity distributions, improving precision of the history information.

In yet another embodiment, the server uses a local generative AI model deployed on the same hardware platform as the storage function, to minimize network latency between the log database and the model. The server pipelines database retrieval and model execution by streaming activity entries as they are read from the storage device into the model input buffer. This allows the server to begin attention computations before the full context has been assembled, reducing end-to-end latency for long histories. The server thus achieves a technical improvement in processing speed compared to an implementation that first fully fetches and formats all activity logs, and then separately calls a remote model.

The system also reduces communication load between the server and the terminal. Because the server returns only summarized history information and topic-grouped results instead of raw per-event logs, the volume of data transmitted over the network is significantly reduced, especially for long-period queries. The terminal therefore processes and renders fewer elements, which results in lower memory usage and faster drawing on the display. The reduction in transmitted data also contributes to lower latency perceived by the user and to improved scalability of the server under heavy load.

The terminal, in these embodiments, does not merely automate a human logging task. The terminal implements non-trivial logic for detecting state transitions of information resources, computing viewing durations, and aggregating activity into structured records suitable for machine processing. The server, in turn, does not simply replicate human analysis but uses specific neural architectures, trained loss functions, and time-series-aligned data structures to perform operations that are technically tailored to the capabilities and constraints of the hardware and network. The combination of these elements results in an integrated system that improves processing efficiency, data organization, and response quality in a manner that is rooted in the functioning of the computer components themselves.

Alternative embodiments may vary the structure of the activity information or the neural network architecture while remaining within the scope of the invention. For example, the server may use a recurrent neural network or a convolutional sequence model instead of a transformer, or may use a smaller model on resource-constrained hardware. The server may embed activity records in a compact binary format instead of text before converting them into tokens. The terminal may be implemented as a mobile device application instead of a desktop browser, while still providing a display control function and an acquisition function that capture identification information and viewing duration. In each case, the server continues to generate prompt sentences embedding structured activity information, input such prompt sentences to a generative AI model, and generate history information in a presentation-ready format, thereby achieving the technical effects described above.

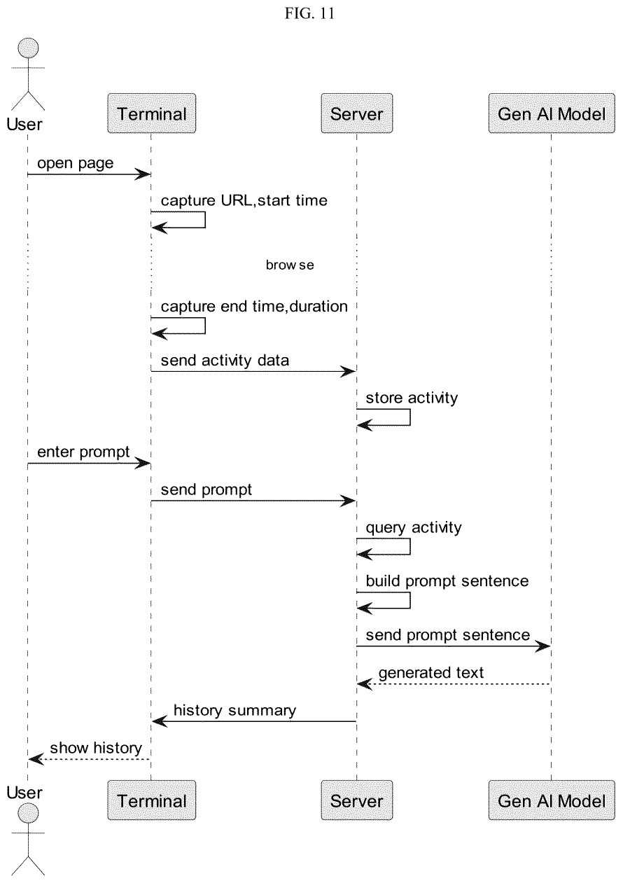

The following describes the processing flow using FIG. 11.

### Step 1:

The user starts a browsing session on the terminal by launching a browser application and opening one or more information resources over a network.

The input to this step is a set of user operations such as entering a URL, clicking a hyperlink, or selecting a bookmark.

The output of this step is one or more loaded information resources rendered in browser tabs or windows on the display of the terminal.

### Step 2:

The terminal activates an extension function as an acquisition function when the browser loads an information resource.

The input to this step is the document object model of the loaded information resource and the browser state (tab identifier, window identifier, focus state).

The terminal reads identification information from the document object model, retrieves title information, and obtains structural information such as element hierarchy and visibility.

The terminal records a start timestamp when the tab or window containing the information resource gains focus and becomes visible.

The output of this step is a preliminary activity record containing at least a user identifier, a resource identifier, title information, and a start time.

### Step 3:

The terminal monitors user interaction events and visibility events to determine viewing duration of each information resource.

The input to this step is the preliminary activity record from Step 2 and a stream of events such as focus, blur, visibility change, tab switch, and page unload signals provided by the browser.

The terminal detects a state transition when the information resource is no longer actively viewed, records an end timestamp, and computes viewing duration by subtracting the start time from the end time.

The terminal enriches the preliminary activity record with the end time and the viewing duration, and may also attach auxiliary attributes such as a referrer and a content type.

The output of this step is a completed activity record for a single viewing episode.

### Step 4:

The terminal structures multiple activity records as time-series activity information and buffers them for transmission.

The input to this step is a sequence of completed activity records generated in Step 3.

The terminal orders the records by start time, groups records by user identifier, and stores them in a local buffer or local storage with a consistent schema including user identification information, resource identification information, title information, start time, end time, and duration.

The terminal applies simple data processing such as removing records with duration below a threshold or merging consecutive records for the same resource within a short gap.

The output of this step is a batch of normalized activity information ready for network transmission.

### Step 5:

The terminal transmits the structured activity information to the server via a communication function.

The input to this step is the batch of normalized activity information from Step 4 and connection parameters for a secure network session.

The terminal serializes the batch into a compact message format, establishes a secure connection using a transport layer security-based protocol, attaches authentication information, and sends the message to a predefined endpoint on the server.

The terminal waits for an acknowledgment from the server and, upon success, clears the transmitted batch from the local buffer; upon failure, the terminal schedules a retry.

The output of this step is a corresponding request received at the server that contains the activity information batch.

### Step 6:

The server receives and validates the incoming activity information from the terminal.

The input to this step is the network message from Step 5 containing the serialized activity information and authentication data.

The server terminates the secure transport protocol, parses the message, and validates the structure and data types of the activity records.

The server checks user identification information against an authentication store, normalizes timestamps into a canonical time zone, and discards or flags invalid records.

The output of this step is a set of validated, normalized activity records associated with a specific user.

### Step 7:

The server stores the validated activity records in a storage function as time-series activity information.

The input to this step is the set of validated activity records from Step 6 and a database schema defining activity tables and indexes.

The server maps each record field to columns in an activity log table, generates insert statements or uses a data access library, and writes the records to the storage device.

The server also updates indexes on user identification information and time fields, and may precompute aggregated statistics such as total viewing duration per resource per day.

The output of this step is a persistent, indexed dataset of activity information that can be efficiently queried by user and time range.

### Step 8:

The user issues a natural-language request to review past activity through a web application interface provided by the server and rendered on the terminal.

The input to this step is the user's intention to retrieve or summarize past browsing behavior.

The user types a prompt sentence such as “Show my browsing history for 2023-10-01.” or “Using my browsing history from 2023-10-01, summarize what topics I mainly read about and group the pages by topic.” into a text input field and submits the request.

The output of this step is a prompt sentence and optional filter parameters captured by the terminal.

### Step 9:

The terminal sends the user's prompt sentence and associated parameters to the server.

The input to this step is the prompt sentence and any structured selection data (for example, calendar dates or checkboxes) obtained in Step 8.

The terminal packages the prompt sentence, user identification information, and optional explicit time range information into a request message and transmits the message to a query endpoint on the server using a secure protocol.

The output of this step is a query request received at the server that includes at least the prompt sentence and user identification information.

### Step 10:

The server interprets the prompt sentence and constructs a database query for relevant activity information.

The input to this step is the query request from Step 9, including the prompt sentence and user identification information.

The server applies natural-language parsing rules and pattern matching to identify date expressions, period expressions, resource type constraints, and summarization instructions in the prompt sentence.

The server derives time range information and query conditions from the parsed result, such as a specific date or a start and end time interval.

The server then generates structured database queries that filter activity information in the storage function by user identification information and by the derived time range and conditions.

The output of this step is a set of query results containing the subset of activity records that correspond to the user's request.

### Step 11:

The server converts the retrieved activity records into a compact context representation for a generative AI model and generates an instruction for the model.

The input to this step is the set of activity records obtained in Step 10 and the parsed understanding of the user's intent from the prompt sentence.

The server sorts the records chronologically, formats them into a textual list including time intervals, URLs or other identifiers, and titles, and optionally omits records that do not meet internal thresholds for viewing duration or relevance.

The server constructs a generative instruction part that explicitly states the required output, such as “generate a chronological activity history” or “group the pages by main topic,” and includes conditions like ignoring very short visits.

The output of this step is a context text representing the activity list and an instruction text capturing the required processing.

### Step 12:

The server generates a model-input prompt sentence by combining the instruction text and the context text, and supplies this prompt sentence to the generative AI model.

The input to this step is the instruction text and context text from Step 11.

The server concatenates these texts in a predefined format, inserts separators or headings to distinguish instructions from data, and forms a single prompt sentence or prompt document for the generative AI model.

The server sets model parameters such as maximum output length and randomness level, and transmits the prompt sentence into the generative AI model interface.

The output of this step is an internal model request that includes the prompt sentence and parameter settings.

### Step 13:

The server obtains generated output from the generative AI model and converts it into structured history information.

The input to this step is the model output text produced in response to the prompt sentence from Step 12.

The server parses the output text to detect sections corresponding to chronological descriptions, topic groupings, and summaries, using markers or patterns defined in the instruction text.

The server maps each described activity back to underlying activity records where necessary, and constructs structured history information including a sequence of events, grouped topics, and summary paragraphs.

The output of this step is machine-readable history information ready for formatting and transmission to the terminal.

### Step 14:

The server prepares a response containing the structured history information and sends it to the terminal.

The input to this step is the structured history information from Step 13 and the original query context.

The server adds metadata such as the covered time range, the number of activities included, and any filters applied, and serializes the complete history information into a response message.

The server transmits the response to the terminal using a secure communication protocol and logs performance metrics such as processing time and record count.

The output of this step is a response message containing the history information as received by the terminal.

### Step 15:

The terminal renders the history information for the user on the display.

The input to this step is the response message from Step 14 containing structured history information and metadata.

The terminal parses the history information, generates visual elements such as lists, timelines, and grouped sections, and draws them on the display under control of the browser or a dedicated application.

The terminal also enables user interaction features such as scrolling, expanding or collapsing topic groups, and issuing additional prompt sentences to refine the view.

The output of this step is an updated screen showing the user a summarized and organized view of the requested activity history.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information recommendation systems typically rely on manually designed features and fixed recommendation algorithms, such as collaborative filtering or simple content-based filtering executed on server-side components. These systems often process user activity logs in a batch-oriented manner and directly map user identifiers or item identifiers to recommendation scores without deeply modeling the semantic content of accessed resources or the context of user activities. As a result, such systems have limited capability to adapt to diverse and evolving user interests, and frequently generate recommendations that are either too generic or irrelevant to the user's current context.

Furthermore, known systems generally treat user activity logs as low-level numerical events (for example, counts of page views or click-through statistics) and do not transform these logs into high-level, semantically rich activity histories optimized for machine interpretation. When these systems attempt to use advanced models, they often supply the models with sparse numerical vectors or shallow metadata, which underutilizes the expressive power of modern generative models. This mismatch leads to sub-optimal use of computational resources and does not fully improve the quality of information retrieval or personalization.

In addition, in traditional architectures, the logic for recommendation ranking is tightly embedded within the application code or within dedicated recommender modules. Such logic is difficult to maintain and extend, and often cannot flexibly incorporate new content types, new domains, or complex user intents without substantial redevelopment. These constraints result in increased development cost, poor scalability of the recommendation logic, and an inability to quickly adapt to new requirements for personalized information delivery.

Moreover, existing approaches that attempt to incorporate large-scale language models or other generative models into recommendation pipelines typically lack a structured mechanism for transforming raw user behavior data into tailored prompt sentences. In many cases, generic prompts are used without sufficiently capturing detailed user interests, temporal constraints, or contextual information about candidate content items. This causes the generative model to produce recommendations that are inconsistent or noisy, and prevents the system from achieving stable, repeatable recommendation performance in a production environment.

There is also a technical challenge in efficiently combining structured user behavior logs, derived interest clusters, and rich metadata of candidate information resources into a unified representation suitable for generative processing. Without a well-defined pipeline that includes: (i) semantic enrichment of behavior logs, (ii) clustering of user interests based on feature extraction, and (iii) structured prompt generation reflecting both user profiles and candidate content metadata, the system cannot systematically improve the precision and relevance of recommendations while maintaining computational efficiency.

Accordingly, there is a need for a computer-implemented technique that improves the functioning of an information processing system by: (a) transforming raw user behavior information and associated content information into structured behavior logs, (b) extracting and clustering high-level user interests from such logs, and (c) automatically generating structured prompt sentences tailored to a generative information processing model. Such a technique should improve the quality, adaptability, and efficiency of recommendation processing, reduce the need for manually coded recommendation rules, and enable more effective utilization of generative models in information provision services.

The specific processing by the specific processing unit 290 of the data processing device 12 in Application Example 1 is realized by the following means.

The present invention provides a server comprising a processor configured to track activities of a user by using an information processing apparatus, acquire behavior information including access information to information resources on a network and information generated by the user with respect to the information resources, acquire structured content information from the information resources on the network based on the behavior information, generate a behavior log including the behavior information and the content information, transmit the behavior log to a data management apparatus and store the behavior log in a data storage area of the data management apparatus, obtain the behavior log from the data storage area, preprocess character information included in the behavior log by using a data processing program, convert the character information into feature values, generate a plurality of cluster information items corresponding to interests of the user based on the feature values, select or extract information on a plurality of candidate information resources to be provided to the user as information provision targets based on the cluster information and the behavior log, generate text data including metadata relating to the plurality of candidate information resources, generate a prompt sentence for causing a generative information processing model to generate recommendation information for each user based on the cluster information and the text data, input the prompt sentence to the generative information processing model, and identify information resources to be presented to the user based on the recommendation information output from the generative information processing model and generate presentation data for outputting an identification result of the information resources to a display apparatus. This enables the server to transform low-level behavior information into semantically enriched behavior logs, to derive structured user interest clusters as internal representations, and to use these representations to construct tailored prompt sentences for a generative information processing model, thereby improving the technical performance of the recommendation pipeline, enhancing the relevance and adaptability of recommended information resources, and reducing reliance on rigid, manually coded recommendation logic in the information processing system.

The term “processor” refers to a hardware or virtual processing unit, such as a central processing unit or a processing core in a computing environment, that executes instructions of one or more programs to perform data processing operations described in this specification and claims.

The term “information processing apparatus” refers to an electronic device, such as a client device, a terminal device, or a computing device, that is capable of executing software for accessing information resources on a network and for generating or transmitting user activity data.

The term “user” refers to a person, entity, or software agent that operates or interacts with the information processing apparatus and causes activities that are tracked and processed by the system.

The term “activity” refers to an operation or interaction performed by the user via the information processing apparatus with respect to an information resource, including, for example, viewing a resource, selecting a link, submitting input data, or generating content.

The term “behavior information” refers to data representing activities of the user, including at least access information to information resources on a network and information generated by the user with respect to the information resources, such as comments, input texts, or selections.

The term “access information” refers to information that indicates that the user has accessed or interacted with an information resource, including, for example, a resource identifier, a timestamp, a session identifier, or an access type.

The term “information resource” refers to any digital content accessible via a network, including, for example, a web page, a document, a media file, an application interface, or another network-accessible data object.

The term “network” refers to a communication infrastructure that enables data transfer between devices, including, for example, a local area network, a wide area network, or a public packet-switched network.

The term “information generated by the user” refers to content or data created or provided by the user through the information processing apparatus, including, for example, text inputs, comments, ratings, selections, or uploaded content.

The term “structured content information” refers to information obtained from information resources on the network that has been organized into a defined data format, such as records or fields including titles, categories, summaries, tags, or other metadata.

The term “behavior log” refers to a dataset or record set that includes behavior information and structured content information associated with user activities, stored in a form suitable for subsequent analysis and processing.

The term “data management apparatus” refers to a computing component or system, such as a server or storage system, that provides a data storage area and functionality for storing, managing, and retrieving data including the behavior log.

The term “data storage area” refers to a logical or physical storage region, such as a database, a file system, or a storage volume, configured to store the behavior log and other related data.

The term “data processing program” refers to software executed by the processor that is configured to perform operations on data, such as preprocessing, feature extraction, aggregation, or transformation of character information in the behavior log.

The term “character information” refers to information expressed as textual data, including, for example, natural language strings, alphanumeric content, or symbolic data extracted from the behavior log.

The term “feature values” refers to numerical or categorical representations derived from character information or other data, suitable for use in computational analysis, such as clustering, classification, or similarity calculation.

The term “cluster information” refers to information indicating grouping or categorization of users or content based on feature values, and includes identifiers and characteristics associated with clusters corresponding to user interests.

The term “interest” refers to a preference, inclination, or topic focus of the user inferred from the behavior log, including recurring themes, categories, or content types that the user tends to access or generate.

The term “candidate information resource” refers to an information resource selected as a potential target for provision to the user, prior to final recommendation, based on at least the cluster information and the behavior log.

The term “information provision target” refers to an information resource that is intended to be presented or made available to the user as part of a recommendation or information delivery process.

The term “metadata” refers to data describing attributes of an information resource, including, for example, a title, category, tag, summary, creation time, or other descriptive property.

The term “text data” refers to data represented in a textual format, including sentences, paragraphs, or structured text segments that describe candidate information resources or user-related information.

The term “generative information processing model” refers to a model implemented by software and executed on computing hardware that generates output data, such as text or structured information, in response to input data, including a generative AI model such as a language model.

The term “prompt sentence” refers to a text sequence or set of text instructions provided as input to the generative information processing model, specifying a task, context, or constraints for generating recommendation information.

The term “recommendation information” refers to information generated by the generative information processing model that indicates one or more information resources to be provided to the user, including, for example, selected items, ranked lists, or explanatory data.

The term “presentation data” refers to data formatted for output to a display apparatus or user interface, including information sufficient to identify recommended information resources and to control their display.

The term “display apparatus” refers to a device or component, such as a screen, monitor, or graphical user interface, that presents information visually to the user.

The term “extension program” refers to a software module or add-on that operates in conjunction with an information processing apparatus, such as a plugin, extension, or auxiliary application, and that is configured to obtain at least the behavior log and the cluster information for prompt generation.

The term “summary information” refers to data that concisely represents the essential aspects of a larger set of information, such as a compressed description of user interests or an abstract of activity history.

The term “identification information” refers to data that uniquely or distinctly specifies an information resource or other entity, such as an identifier, index, or reference value.

The term “ranking” refers to an ordering of items, such as candidate information resources, based on relevance, preference, or another criterion, as determined by a computational process.

The term “designation information” refers to data indicating a specific date, time, or period, used to filter or select behavior logs corresponding to a temporal range.

The term “activity history” refers to a chronological or logically ordered representation of activities performed by the user, derived from the behavior log and optionally summarized or transformed for analysis.

In one embodiment, a server cooperates with a terminal operated by a user to implement a recommendation system that generates personalized information resources by using behavior logs, clustering, and a generative AI model controlled via structured prompt sentences. The following description illustrates exemplary hardware and software configurations and concrete data processing operations that enable a person skilled in the art to implement the claimed invention.

### A. Overall System Configuration

Server includes at least one processor, a main memory, a non-volatile storage device, and a network interface. Server operates on a general-purpose computing platform, such as a rack-mounted computer or a virtual machine instance in a data center. Server executes an operating system, such as a general-purpose server operating system, and provides a runtime environment for application programs implemented, for example, in a high-level programming language.

Terminal includes a processor, a memory, a display apparatus, and a communication module. Terminal can be a smartphone, a tablet, a notebook computer, or another user device capable of executing a web browser or a dedicated application. Terminal executes an operating system such as a mobile operating system or a desktop operating system and a client program or browser extension that communicates with server and records user activities.

User operates terminal to access information resources over a network. User may view web pages, open documents, consume media, and generate content such as comments or text posts. User does not need to perform any special operation to invoke the recommendation pipeline; the tracking, analysis, and recommendation processes are performed by server and terminal transparently.

### B. Acquisition of Behavior Information and Generation of Behavior Logs

Terminal executes a logging module that intercepts or records events generated during user interaction with information resources. Terminal records, as behavior information, at least an accessed resource identifier (for example, a uniform resource locator), a timestamp, an event type (such as page view, click, comment submission), and content generated by user, such as textual comments. Terminal temporarily buffers this behavior information in a local storage area, such as a lightweight local database.

Server receives the behavior information from terminal via a secure communication protocol. Server exposes an application programming interface (API) endpoint that accepts requests containing behavior information in a predefined data structure. Server parses the received data and normalizes it into an internal event representation having fields such as user identifier, resource identifier, event type, timestamp, and user-generated text.

Server acquires structured content information corresponding to the accessed information resources. In one embodiment, server uses a web content acquisition module implemented using a scripting language and a hypertext parser library to retrieve and parse the content of the accessed resources. Server issues HTTP requests or controls a headless browser to load the resource, retrieve the markup document, and extract elements such as a title, main body text, category labels, tags, and author or source metadata.

Server combines the behavior information and the structured content information to form behavior logs. Each behavior log record includes identifiers, timestamps, user-generated text, and resource-level metadata (for example, title, category, tags, summary). Server stores these behavior logs in a data management apparatus, such as a relational database management system. Server defines a schema with tables for user activities and content metadata and uses indexing on user identifiers and timestamps to support efficient retrieval. By unifying events and resource metadata into behavior logs, server creates a structured data representation that is not available in conventional systems that treat user logs and content metadata separately. This unified representation enables more accurate and efficient subsequent processing, such as clustering and prompt generation.

### C. Preprocessing and Feature Extraction for Clustering User Interests

Server performs data preprocessing on the character information contained in the behavior logs. Server retrieves behavior log records from the data management apparatus and applies text normalization operations, including tokenization, lowercasing, removal of punctuation, and removal of stopwords. In some embodiments, server uses a natural language processing library to perform stemming or lemmatization to reduce inflectional variations to base forms.

Server aggregates behavior log records per user to generate a profile text for each user. Server concatenates titles, categories, tags, and user-generated texts associated with each user into a single textual sequence, while optionally applying weighting schemes (for example, assigning higher weight to user-generated comments than to resource titles). This profile text forms the basis for feature extraction.

Server converts the profile text into feature values. In one embodiment, server uses a term weighting scheme such as term frequency-inverse document frequency to encode the profile text as a high-dimensional sparse vector. Each dimension corresponds to a vocabulary term, and the component value is a weight representing the relative importance of that term for the user. In another embodiment, server uses a neural embedding model to transform the profile text into a dense vector representation in a lower-dimensional real-valued space. Server uses these feature values to perform clustering. Server executes a clustering algorithm, such as a centroid-based clustering algorithm or a density-based clustering algorithm, to partition users into groups with similar interest patterns. Server calculates distances or similarities between feature vectors using a metric such as cosine similarity or Euclidean distance. Server assigns each user to a cluster and generates cluster information that includes, for each cluster, a cluster identifier and characteristic terms or topics derived from the cluster centroid or density region.

In another embodiment, server uses a topic modeling algorithm or a neural topic encoder to derive multiple interest topics per user. Server then represents cluster information as a set of topic identifiers and associated probabilities for each user. This allows server to reflect complex, multi-faceted interests rather than a single cluster assignment.

This clustering process improves the technical operation of server by compressing high-dimensional and noisy behavior data into structured interest representations. These representations reduce memory and computation requirements for downstream processing, thereby improving processing speed and scalability when generating recommendations for a large population of users.

### D. Selection of Candidate Information Resources

Server selects candidate information resources that may be recommended to user. Server maintains a content catalog in the data management apparatus, including identifiers, titles, categories, tags, publication dates, and other metadata for available resources. Server retrieves cluster information for a target user and filters the content catalog based on categories, tags, or terms that match the user's interest clusters.

Server excludes resources already consumed by user by matching resource identifiers present in the behavior logs. Server may also apply freshness criteria, such as discarding resources older than a threshold date, or apply popularity scores to prioritize frequently accessed resources. The result is a list of candidate information resources tailored to user's inferred interests and temporal preferences.

Server converts selected candidate resources into text data suitable for use in prompt sentences. For each candidate, server constructs a natural language description including at least a title, category, and short summary, and may additionally include tags or a compact representation of content. Server orders these descriptions and indexes them so that a generative AI model can refer to them symbolically (for example, by candidate index) in its output.

### E. Generative AI Model Configuration

Server uses a generative AI model, implemented as a trained neural network, to generate recommendation information. In one embodiment, server uses a sequence-to-sequence language model based on a transformer architecture. The model includes an encoder and a decoder with multiple layers of self-attention units, feed-forward networks, and normalization layers. The model parameters include weight matrices and bias vectors that are learned during a pre-training and fine-tuning process.

Server trains or fine-tunes the generative AI model on training data that includes pairs of input prompt sentences and output recommendation sequences. The training process minimizes a loss function, such as cross-entropy between predicted token distributions and ground truth tokens, using stochastic gradient descent or a variant such as Adam. Server updates the model weights iteratively based on the gradient of the loss with respect to the parameters.

Server may use data augmentation techniques, such as paraphrasing candidate descriptions, shuffling candidate lists, or adding synthetic interest profiles, to increase training data diversity. Server can store model parameters in a model repository and load them into an accelerator device such as a graphics processing unit or a specialized neural network accelerator for high-throughput inference.

By explicitly defining the architecture, loss function, and training process, server implements a generative AI model that can process structured prompt sentences and produce consistent, context-aware recommendation outputs. This configuration improves the internal operation of the computing system by optimizing resource usage and reducing the need for manual rule-based recommendation logic.

### F. Prompt Sentence Generation

Server generates a prompt sentence that encodes user's cluster information and candidate resource metadata. Server constructs the prompt sentence by concatenating segments that describe:
(1) user's interest summary, derived from cluster information;
(2) a list of candidate information resources with indexed descriptions; and
(3) explicit instructions for the generative AI model about the task, constraints, and output format.

For example, for a user whose clusters indicate strong interest in technology gadgets and a secondary interest in programming, server can generate a prompt sentence such as:

“You are a generative AI model that selects relevant content for a user.

The user is mainly interested in technology gadgets such as smartphones, tablets, and laptops, and secondarily in programming tutorials.

Below is a list of candidate articles, each with a title, category, and short summary:
1. Title: ‘Latest Foldable Smartphone Review’
   Category: Technology
   Summary: A detailed hands-on review of a new foldable smartphone.
2. Title: ‘Compact Android Phones Comparison’
   Category: Technology
   Summary: A comparison of several compact smartphones focusing on size and battery life.
3. Title: ‘Beginner's Guide to Programming Functions’
   Category: Programming
   Summary: An introductory tutorial about functions in a general-purpose programming language.
4. Title: ‘Top Travel Destinations This Year’
   Category: Travel
   Summary: An overview of recommended travel spots around the world.

Based on the user's interests, select the 5 most relevant articles from the above list and output the titles and indices of the selected articles, together with a one-sentence explanation for each choice.”

In another example, server can generate a prompt sentence that requests a temporal summary:

“You are a generative AI model that summarizes a user's activity history.

The following text describes the user's browsing and commenting behavior between 2026-01-01 and 2026-01-31, including titles, categories, and user comments.

Please summarize the main topics of interest during this period and list 3 themes with short explanations.”

Server generates these prompt sentences automatically by programmatically inserting cluster labels, candidate descriptions, and instruction phrases into a template structure. This non-conventional, structured prompt generation ensures that the generative AI model receives detailed, explicit context, which improves the determinism and accuracy of recommendations compared to ad hoc or human-authored prompts.

### G. Generation and Post-Processing of Recommendation Information

Server inputs the generated prompt sentence into the generative AI model. Server encodes the prompt sentence into token identifiers using a tokenizer compatible with the model architecture. Server feeds the tokens to the model, which computes attention-based transformations layer by layer and generates output tokens according to a decoding algorithm, such as greedy decoding or beam search, subject to a maximum length constraint.

Server decodes the output tokens into a text output and parses the output to extract recommendation information. For example, if the output lists selected indices and reasons, server parses each line to identify an index and an explanation. Server maps the index back to the corresponding candidate information resource in its catalog.

Server then generates presentation data for terminal. Presentation data includes the selected resource identifiers, titles, summaries, and explanations. Server packages this presentation data in a form suitable for display on terminal, such as a structured data response.

This generation and post-processing pipeline is specifically optimized to work with structured behavior logs and cluster information. It provides an improvement over conventional systems by effectively constraining and guiding the generative AI model, thereby reducing hallucinated outputs and increasing recommendation precision. The structured prompt and parsing method allows server to operate the model as a controllable computational module, rather than as a generic text generator.

### H. Display and User Interaction

Terminal receives the presentation data from server. Terminal renders the recommended resources on the display apparatus as a list or grid of items. Terminal shows, for each item, at least a title, an optional thumbnail image, a brief summary, and, in some embodiments, a “why recommended” explanation derived from the recommendation information.

User can scroll through the list and select an item to view. Terminal sends follow-up interactions, such as recommendation impressions and clicks, back to server as additional behavior information. Server incorporates these follow-up interactions into future behavior logs, closing a feedback loop that allows the clustering and prompt generation processes to adapt over time.

### I. Technical Effects and Improvement of Computer Technology

Server improves computer technology in several concrete ways. By transforming raw behavior information into structured behavior logs and then into compact cluster information, server reduces the dimensionality and redundancy of data stored and processed in memory and persistent storage. This results in reduced storage requirements and improved cache utilization during feature extraction and clustering, thereby increasing processing throughput when handling large-scale user populations.

Server improves the accuracy of recommendations by integrating behavior logs, cluster information, and candidate metadata into a single, structured prompt sentence. This design provides the generative AI model with rich, machine-optimized context, which differs from conventional systems that either feed sparse numerical vectors to a non-generative model or supply unstructured, incomplete text prompts. As a result, server reduces error rates in recommendation selection, as measured by offline metrics such as precision and recall or online metrics such as click-through rate.

Server reduces communication load and computation load by performing clustering and candidate selection before invoking the generative AI model. Instead of sending the entire content catalog or all historical logs to the generative model, server pre-filters and compresses the input into a concise prompt sentence that still contains the essential information required for decision making. This hierarchical processing architecture leads to lower latency, decreased inference cost, and more efficient network utilization.

Server uses non-conventional algorithms and representations that go beyond automating human judgment. Human operators cannot feasibly process thousands of behavior log entries per user, derive abstract interest clusters using high-dimensional feature spaces, and construct consistent, parameterized prompt sentences for every inference request. Server performs such tasks by using explicit algorithms for feature extraction, clustering, and template-based prompt generation, which are tailored to the internal architecture of the generative AI model. This synergy between data structures and model architecture constitutes an improvement to the functioning of the computer system as a recommendation engine. Server also improves data management by unifying logs and content metadata in a schema optimized for downstream analysis, by applying indexing strategies, and by designing the pipeline so that intermediate data products (such as cluster information and profile texts) can be cached and reused. This reduces redundant computation when similar requests are repeatedly issued for the same user or cluster.

### J. Alternative Embodiments and Variations

Server can implement different feature extraction techniques, such as character n-gram models, sentence embeddings, or graph-based representations of user-resource interactions. In each variation, server still converts behavior logs into numerical feature values and derives cluster information that summarizes user interests.

Server can use various clustering algorithms, such as hierarchical clustering or spectral clustering, depending on data distribution and scalability requirements. Server may apply online clustering methods that update cluster assignments incrementally as new behavior logs are received, thereby maintaining up-to-date interest profiles without fully recomputing clusters.

Server can employ different generative AI model architectures, including decoder-only transformer models or encoder-decoder transformer models, and can adjust hyperparameters such as the number of layers, hidden dimension size, number of attention heads, and learning rate schedule. Server can also integrate safety filters and constraint decoding to ensure that the generated recommendation information adheres to policy requirements.

Server may generate different types of prompt sentences depending on the application. For example, server can generate a prompt sentence that asks for ranking only:
“You are a generative AI model used in a recommendation system.
The user is interested in technology gadgets and general programming topics.
Here are candidate articles with titles and short summaries:
(1) . . .
(2) . . .
(3) . . .
Rank these articles from most to least relevant to the user, and output the ordered list of indices.”

In another variant, server can generate a prompt sentence that requests not only selection and ranking but also generation of new abstract descriptions or headlines. Server can adjust the template based on system goals, such as maximizing diversity or emphasizing recency.

Through these embodiments and variations, server uses specific data structures, feature extraction methods, clustering algorithms, prompt sentence templates, and transformer-based generative AI models to implement an end-to-end recommendation pipeline that improves technical performance, including increased computational efficiency, higher recommendation accuracy, and reduced communication overhead, and that goes beyond mere automation of human mental processes.

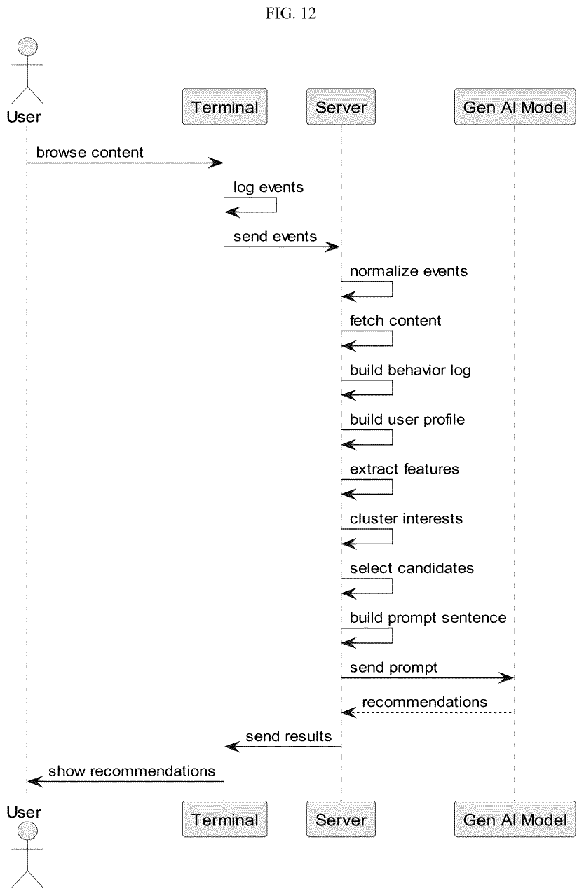

The following describes the processing flow using FIG. 12.

### Step 1:

User operates terminal to access information resources over a network.

User opens a browser or an application on terminal and requests web pages, documents, or media. The input to this step is a user action, such as entering a URL, clicking a link, or submitting a search query. The output of this step is a set of concrete interactions with information resources, including resource identifiers (for example, URLs), timestamps, and user-generated content such as comments or text inputs.

### Step 2:

Terminal records behavior information associated with user interactions.

Terminal executes a logging module that intercepts events such as page views, link clicks, and comment submissions. The input to this step is the raw interaction data generated when user views or manipulates content on the display. Terminal converts each interaction into an event record including at least a user identifier, a resource identifier, an event type, and a timestamp, and includes user-generated text when available. Terminal stores these event records in a local buffer or local storage. The output is a structured behavior event list ready to be transmitted to server.

### Step 3:

Terminal transmits the behavior event list to server.

Terminal packages multiple event records into a request payload and sends the payload to server via a communication interface, such as an HTTPS connection to an application programming interface endpoint. The input is the locally buffered behavior event list, and the output is a network message containing these events encoded in a predefined structured format. Terminal may perform retry operations and batch events to reduce communication overhead before server receives the data.

### Step 4:

Server receives and normalizes the behavior event list.

Server listens on a network interface for incoming requests from terminal. The input is the structured payload containing user identifiers, resource identifiers, event types, timestamps, and optional user-generated text. Server parses the payload, validates mandatory fields, and converts values to normalized internal formats, such as converting timestamps to a common time zone and mapping external identifiers to internal identifiers. Server stores the normalized events in a temporary processing buffer. The output is a cleaned and normalized event dataset suitable for further processing.

### Step 5:

Server acquires structured content information for accessed resources.

Server analyzes the normalized event dataset to extract unique resource identifiers that require content retrieval. The input is the set of resource identifiers from the behavior events. Server uses a content acquisition module to send network requests or control a headless browser to retrieve resource documents. Server parses the returned documents to extract elements such as titles, main text, categories, tags, and summaries. Server converts these elements into structured content records associated with each resource identifier. The output is a set of structured content information entries mapped to resource identifiers.

### Step 6:

Server generates behavior logs by combining behavior information and content information.

Server merges the normalized event dataset with the structured content information based on matching resource identifiers. The input to this step is the event dataset (user, resource, event type, timestamp, user-generated text) and the content records (title, main text, category, tags, summary). Server creates a behavior log record for each event, including both event fields and content metadata. Server stores these behavior logs in a data management apparatus, such as a database, and creates indices on user identifiers and timestamps. The output is a persistent behavior log table or collection that unifies user actions and resource content.

### Step 7:

Server retrieves behavior logs and builds per-user profile texts.

Server queries the data management apparatus to extract behavior log records grouped by user. The input is the stored behavior log table filtered by user identifiers or time ranges. Server processes each record to select character information fields, such as titles, categories, tags, and user-generated text, and concatenates them into a profile text for each user. Server may apply weighting by duplicating or marking more important fields. The output is a mapping from user identifiers to profile texts that summarize each user's overall interactions.

### Step 8:

Server preprocesses profile texts and extracts feature values.

Server takes the profile texts as input and performs text preprocessing operations such as tokenization, lowercasing, and removal of stopwords and punctuation. Server optionally performs stemming or lemmatization to consolidate word forms. Server then applies a feature extraction technique, such as a term frequency-inverse document frequency encoder or a neural embedding encoder, to convert each profile text into a numerical feature vector. The output is a set of feature vectors, each representing a user's interests in a high-dimensional or dense vector space.

### Step 9:

Server clusters users based on feature vectors to derive interest profiles.

Server receives the feature vectors as input and uses a clustering algorithm to group similar vectors. Server computes similarity or distance metrics between vectors and assigns each user to one or more clusters. Server may compute cluster centroids and identify top features associated with each cluster. The output of this step is cluster information, including a cluster identifier for each user and associated descriptive terms or topics that characterize the cluster, forming an interest profile for each user.

### Step 10:

Server selects candidate information resources based on cluster information and behavior logs.

Server uses the user's cluster information as input along with the content catalog stored in the data management apparatus. Server filters the content catalog to identify information resources whose categories, tags, or textual descriptors match the user's interest clusters. Server uses the behavior logs to exclude resources that user has already consumed or to preferentially include newer or highly rated resources. The output is a candidate resource list containing identifiers, titles, categories, tags, and summaries for resources that are potentially relevant to the user.

### Step 11:

Server generates text descriptions for candidate resources.

Server takes the candidate resource list as input and constructs human-readable descriptions for each candidate. Server combines the title, category, and summary into a compact description and assigns a sequential index to each candidate. Server orders the candidates based on heuristic criteria, such as recency or relevance score. The output of this step is ordered text data that lists each candidate resource with its index, title, category, and short description.

### Step 12:

Server composes a prompt sentence reflecting user interests and candidate resources.

Server uses the cluster information and the ordered candidate descriptions as input and fills in a predefined template to create a prompt sentence for a generative AI model. Server inserts a textual summary of user interests derived from cluster information, followed by the indexed candidate descriptions, and then appends explicit instructions for selection, ranking, and explanation. For example, server may generate a prompt sentence such as:

“You are a generative AI model that selects relevant content for a user.

The user is mainly interested in technology gadgets such as smartphones, tablets, and laptops, and secondarily in programming tutorials.

Below is a list of candidate articles, each with a title, category, and short summary:
1. Title: ‘Latest Foldable Smartphone Review’
   Category: Technology
   Summary: A detailed hands-on review of a new foldable smartphone.
2. Title: ‘Compact Android Phones Comparison’
   Category: Technology
   Summary: A comparison of several compact smartphones focusing on size and battery life.
3. Title: ‘Beginner's Guide to Programming Functions’
   Category: Programming
   Summary: An introductory tutorial about functions in a general-purpose programming language.

Based on the user's interests, select the 5 most relevant articles from the above list and output the titles and indices of the selected articles, together with a one-sentence explanation for each choice.”

The output is a complete prompt sentence string tailored to the specific user and candidate set.

### Step 13:

Server inputs the prompt sentence to the generative AI model and obtains recommendation information.

Server takes the prompt sentence as input and encodes it into tokens suitable for the generative AI model, such as a transformer-based language model. Server feeds the tokens to the model and runs an inference process, where the model computes internal attention operations and produces output tokens representing the model's choices and explanations. Server decodes the tokens back into text and parses the text to extract the indices, titles, and reasons for the recommended candidates. The output is a structured recommendation information set that identifies which candidate resources are recommended and why.

### Step 14:

Server generates presentation data based on the recommendation information.

Server uses the recommendation information and the candidate resource list as inputs. Server matches each recommended index to the corresponding resource entry and collects its title, identifier, and summary. Server combines this information with the explanation text provided by the generative AI model to compose presentation data structured for display on terminal. The output is a presentation dataset that includes, for each recommended item, at least a title, summary, resource identifier, and a “why recommended” explanation.

### Step 15:

Server transmits the presentation data to terminal.

Server accepts a request for recommendations from terminal and responds with the presentation dataset generated in Step 14. The input is the internal presentation dataset, and the output is a response message sent over the network to terminal. Server may perform compression or encoding to optimize transmission efficiency.

### Step 16:

Terminal displays recommended information resources to user.

Terminal receives the presentation dataset as input and interprets its structure. Terminal generates user interface components, such as a list or grid of items, and populates each item with the title, summary, and explanation text. Terminal renders these components on the display apparatus, allowing user to scroll and select items. The output of this step is a visible recommendation interface, and subsequent user selections generate new behavior information that will be processed again starting from earlier steps in the flow.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems for presenting a user with summaries of online information typically rely on static recommendation rules, simple keyword aggregation, or pre-defined content feeds. In such systems, a computing device may track basic browsing activity, such as visited network locations and timestamps, but the captured data is stored in a raw or semi-structured form and is not systematically transformed into higher-level, topic-organized representations that can be directly consumed by advanced machine learning models. As a result, the underlying computer processing pipeline is inefficient and cannot fully exploit the capabilities of generative AI models to produce coherent, user-specific narratives of past activity.

In many existing architectures, activity logs are treated merely as passive records used for analytics or advertising, rather than as structured, semantically enriched inputs to a programmatic content-generation workflow. The processor typically does not execute tightly integrated operations that (i) automatically collect access information from a user terminal, (ii) retrieve and normalize content from associated information resources, (iii) perform natural language processing to derive topic-level structured information, and (iv) dynamically generate and supply prompt sentences and structured input data to a generative AI model based on that information. Consequently, the computation is fragmented across unrelated modules, increasing processing latency, consuming excess memory and network resources, and reducing the quality and relevance of generated summaries.

Furthermore, conventional systems do not provide a robust mechanism for enabling a user to retrospectively review activities over specific dates or periods using generated textual summaries that are grounded in semantically organized activity data. Existing solutions often require manual query construction or ad hoc filtering of logs, which imposes a cognitive and operational burden on the user and on the computing infrastructure. From a computer-technology perspective, this lack of an integrated, automated pipeline for transforming low-level activity signals into structured prompts and inputs for a generative AI model results in suboptimal utilization of processor resources, fragmented data flows between terminal devices and servers, and limited scalability for handling large volumes of user activity data.

Accordingly, there is a need for a computer-implemented system that improves the manner in which processors collect, structure, and process user activity information, by defining a specific sequence of technical operations that: (1) acquire and normalize access information from terminal-side functions, (2) perform natural language processing to attach topic information to activity records as structured information, and (3) automatically construct and provide prompt sentences and associated input information to a generative AI model to generate activity histories and topic-specific summaries. By implementing such a pipeline, the computer system can more efficiently utilize processing, storage, and network resources, and can generate higher-quality, contextually consistent summaries that allow a user to efficiently review and understand past activities over arbitrary dates or periods.

The specific processing by the specific processing unit 290 of the data processing device 12 in Example 2 is realized by the following means.

The present invention provides a server comprising a processor and a storage device, the processor being configured to execute a series of computer-implemented operations including tracking user actions to acquire access information relating to information resources from a user terminal, generating activity information including identification information, time information, and dwell time information contained in the access information, obtaining content information of the information resources corresponding to the activity information via a communication network, executing natural language processing on the content information to extract topic information, storing, in the storage device, structured information in which the topic information is associated with the activity information, selecting, from the structured information, a plurality of information resources associated with a predetermined topic, generating input information including title information, summary information, and relevance indicator information of the plurality of information resources, creating, based on the input information, a prompt sentence for instructing a generative AI model to generate a user activity history or topic-specific summary content, inputting the prompt sentence and the input information into the generative AI model, obtaining text information generated by the generative AI model, and providing the generated text information, as output information, to the user terminal. This enables the computing system to transform low-level activity signals into semantically structured data optimized for generative processing, to reduce fragmentation and inefficiency in data handling between the user terminal and the server, to improve utilization of processing and storage resources during topic analysis and summary generation, and to deliver coherent, personalized textual summaries that allow users to efficiently review and understand their activities over specified dates or periods.

The term “user action” refers to an operation or behavior performed by a user on a computing device, including, but not limited to, opening a resource, navigating to a network location, selecting a link, or closing a resource display.

The term “access information” refers to data indicating that a user device has accessed an information resource, including at least a resource identifier, a time at which access occurred, and optionally a duration or frequency of access.

The term “information resource” refers to a data object accessible via a communication network, including, for example, a web page, a document, a media file, or other network-accessible content.

The term “activity information” refers to structured data derived from access information that represents a user's interactions with information resources, and that includes at least identification information, time information, and dwell time information.

The term “identification information” refers to data that uniquely or quasi-uniquely identifies an entity, such as a user, a device, or an information resource, including, for example, a user identifier, a device identifier, or a resource identifier.

The term “time information” refers to data representing a point in time or a time interval associated with an event, including, for example, a timestamp, a start time, an end time, or a date.

The term “dwell time information” refers to data indicating a length of time that a user remains engaged with an information resource, such as a duration between an access start time and an access end time.

The term “content information” refers to data representing the substance or body of an information resource, including textual content, metadata, or other semantically meaningful elements extracted from the resource.

The term “communication network” refers to an infrastructure that enables data transmission between computing devices, including, for example, a local area network, a wide area network, or a public network such as the Internet.

The term “natural language processing” refers to a set of computational techniques for analyzing or generating human language data, including operations such as tokenization, part-of-speech tagging, entity recognition, topic extraction, or text classification.

The term “topic information” refers to data that represents a subject, theme, or category to which content information is assigned, including, for example, a topic label, a category identifier, or an associated confidence score.

The term “structured information” refers to data that is organized according to a predefined schema or format, such that relationships between elements, including associations between activity information and topic information, are explicitly represented.

The term “storage device” refers to a physical or virtual component capable of storing data under control of a processor, including, for example, a magnetic disk, a solid-state memory, or a network-accessible storage system.

The term “title information” refers to data representing a name, headline, or other identifying textual descriptor of an information resource.

The term “summary information” refers to data representing a condensed representation of content information, including, for example, an abstract, a key-point list, or a shortened text describing the main ideas of the content.

The term “relevance indicator information” refers to data indicating a degree or measure of relevance of an information resource with respect to a topic, user, or context, including, for example, a score, a rank, or a weight.

The term “input information” refers to data supplied to a processing component, including a generative AI model, and comprising at least title information, summary information, and relevance indicator information of a plurality of information resources.

The term “prompt sentence” refers to a textual instruction or query provided to a generative AI model, defining a task to be performed and specifying how the model should generate output based on associated input information.

The term “generative AI model” refers to a machine learning model configured to generate data, including text data, in response to input such as a prompt sentence and contextual information.

The term “user activity history” refers to a representation, in textual or structured form, of a sequence of user actions or interactions with information resources over a period of time.

The term “topic-specific summary content” refers to generated text that summarizes information resources associated with a particular topic or subject area derived from structured information.

The term “text information” refers to data comprising one or more character strings or textual segments generated or processed by a computing device, including natural language sentences and paragraphs.

The term “user terminal device” refers to a computing apparatus operated by a user for accessing information resources or receiving generated content, including, for example, a personal computer, a tablet device, or a mobile communication device.

The term “extension function” refers to a software component that extends or augments functionality of an application executing on a user terminal device, such as a plugin, add-on, or module.

The term “application function” refers to a software component or module that is part of an application program executing on a user terminal device, configured to perform specific processing related to access information or activity information.

The term “date information” refers to data indicating a calendar date or related temporal designation associated with an activity, including, for example, a specific day, month, or year.

The term “period information” refers to data indicating a span or interval of time, such as a start date and an end date, used to delimit a subset of activity information.

The term “related information” refers to text or data generated or selected based on a relationship to activity information, such as explanations, summaries, or contextual descriptions associated with user actions.

The term “retrospective information” refers to text or data that describes, interprets, or summarizes past user activities over a specified date or period, enabling review or reflection on such activities.

In one embodiment, a server cooperates with a plurality of terminals to implement the claimed system. The server includes at least one processor, a main memory, a non-volatile storage device, and a network interface coupled via a bus. The terminal includes a processor, a memory, a display device, an input device, and a network interface. The server and the terminal communicate over a communication network such as the Internet, a wireless network, or a local area network using standard transport and application protocols.

The terminal executes an operating system such as a general-purpose desktop operating system or a mobile operating system, and runs an application program such as a web browser or a dedicated client application. The terminal further executes an extension function or application function implemented, for example, as a browser add-on, a plug-in, or a background service. The server executes an operating system and one or more server-side application programs, including a web application framework implemented, for example, using a scripting language runtime. The server also executes a database management system such as a relational database system.

The terminal acquires access information relating to information resources that the user visits. The terminal detects events such as “document loaded,” “tab activated,” and “tab closed” generated by the browser or client application. The terminal records, for each accessed information resource, an identifier of the resource (for example, a uniform resource locator), a timestamp indicating a time at which the resource was opened, and a timestamp indicating a time at which the resource was closed or deactivated. The terminal computes dwell time information as a difference between the open time and the close time. The terminal generates activity information including at least identification information, time information, and dwell time information and stores it temporarily in a local data structure, such as a tabular record storage in a local database on the terminal.

The terminal transmits the activity information to the server via the communication network using an application protocol such as HTTP over a secure transport. The terminal structures the activity information as records that include a user identifier, a device identifier, a resource identifier, a start time, an end time, and a dwell time value. The terminal may batch multiple records together to reduce transmission overhead, thereby lowering communication load and improving overall system throughput.

The server receives the activity information via an application programming interface endpoint implemented by a web application framework. The server validates the record formats, normalizes timestamp formats into a canonical representation such as coordinated universal time, and assigns sequence numbers or primary keys to each activity record. The server stores the activity information in a storage device, for example, in a relational table having columns for user identifier, resource identifier, start time, end time, dwell time, and optionally additional metadata fields. The server may use indexed columns on user identifier and time fields to accelerate range queries and topic-based queries, thus improving data retrieval performance.

The server obtains content information of the information resources referenced by the activity information. The server issues network requests to the resource identifiers included in the activity information using an HTTP client library. The server receives content data such as markup documents. The server filters out unsupported content types and error responses and stores the raw content in a content table or a content storage region.

The server executes natural language processing on the content information in order to extract topic information. The server loads a natural language processing library and processes each content record to perform operations including tokenization, part-of-speech tagging, and sentence segmentation. The server applies a lemmatization process and removes stopwords to generate a normalized token sequence. The server computes numerical feature vectors representing the content using predefined feature extraction methods, such as term frequency-inverse document frequency weighting or word embedding aggregation. The server applies a topic classification algorithm, such as a classifier trained on labeled topic datasets, to assign one or more topic labels to each content record. The server stores the topic labels and associated confidence scores as topic information in association with the corresponding activity information, thereby generating structured information. In this embodiment, the structured information is stored as records that link user identifiers, resource identifiers, temporal data, dwell time data, and topic labels in a unified schema.

The server selects, from the structured information, a plurality of information resources associated with a predetermined topic. The server may use filters based on topic label, time range, and minimum dwell time threshold. For example, the server may select all resources labeled with an environmental topic viewed by the user during the last seven days and having a dwell time exceeding a specified duration. The server ranks the selected resources according to multiple criteria, including dwell time, recency, and topic confidence score, and chooses a subset of resources having the highest ranking. The server generates input information including, for each selected resource, title information, summary information, and relevance indicator information. The server may generate summary information by applying an extractive summarization algorithm such as selecting sentences with the highest scores computed by a scoring function over the feature vectors. The relevance indicator information may include a numerical score that is a weighted combination of dwell time, recency, and topic confidence.

The server constructs a prompt sentence for a generative AI model using the input information. The server composes the prompt sentence in natural language and includes instructions regarding the desired length, style, and structure of the output. For example, the server may construct a prompt sentence such as:

“You are a generative AI model that summarizes user browsing history. The user has recently read the following news articles about environmental issues. Using the titles and excerpts below, write a clear, 800-word summary article that explains the main developments in climate policy and renewable energy. Focus on what has changed recently and why it matters. Articles: [list of titles, dates, and short excerpts].”

In another example, the server may construct a prompt sentence such as:

“From the user's recent web browsing history, summarize and organize the main points of news related to environmental issues. Write a summary article that explains the current situation, recent policy changes, and potential future developments in clear language. Use the following article information as your source data: [list of article titles, resource identifiers, and short descriptions].”

The server uses template-based generation of the prompt sentence, in which slots for topic names, time periods, and summary length are filled with parameters derived from the structured information. This template-based approach ensures that the prompt sentences are consistent and optimized for the generative AI model, which improves generation stability and reduces variance in the model's output.

The server inputs the prompt sentence and the input information into a generative AI model. In one embodiment, the generative AI model is implemented as a transformer-based neural network with multiple attention layers, trained on a large corpus of text data. The server encodes the prompt sentence and the input information as token sequences using a specific tokenization scheme. The generative AI model includes an embedding layer, a stack of self-attention layers, and a decoder that outputs token probability distributions. During training, the neural network uses a loss function such as cross-entropy between predicted token distributions and ground-truth next tokens and updates its weights using gradient-based optimization such as stochastic gradient descent with adaptive learning rates. The model may be fine-tuned on summary-specific datasets to better generate topic-specific summary content.

The server executes the generative AI model using specified inference parameters, such as maximum output length, temperature, and top-k or nucleus sampling thresholds. The server generates output tokens sequentially until a stop condition is met. The server decodes the tokens into text information and performs validation checks such as length constraints and character encoding checks. The server stores the generated text information in association with the corresponding user and topic.

The server provides the generated text information, as output information, to the terminal. The server prepares a response message that includes the summary text, the topic label, and links to the original information resources. The server transmits the response to the terminal via the communication network. The server may compress the data or apply streaming transmission to reduce latency and bandwidth usage, which contributes to reduced communication load and improved user experience.

The terminal receives the output information and displays the generated text information on the display device. The terminal renders the summary text with headings and clickable links to the underlying information resources. The user interacts with the summary by reading the text, selecting links, or providing feedback through input operations such as button presses or text input. The terminal may send feedback data to the server, such as ratings or user preferences, which the server stores as additional structured information. The server may use the feedback to adjust ranking weights or to modify future prompt sentences, thereby improving personalization and technical performance over time.

In one embodiment, the server enables the user to specify a date or period using an input on the terminal, such as selecting a date range from a graphical control. The terminal transmits the specified date information or period information to the server. The server queries the structured information to extract activity information corresponding to the specified date or period. The server then constructs a prompt sentence that instructs the generative AI model to generate related information or retrospective information describing the user's activities during that date or period. For example, the server may construct a prompt sentence such as:

“Using the following list of web pages that the user visited between [start date] and [end date], generate a retrospective summary that describes the main topics the user focused on, highlights significant changes over time, and explains any recurring themes. Present the summary in clear, chronological order. Pages: [list of titles, timestamps, and short excerpts].”

The server provides the constructed prompt sentence and related input information to the generative AI model, receives generated retrospective information, and sends it back to the terminal for display.

This architecture improves computer technology in several ways. The server imposes a specific data structure on raw activity data, transforming unstructured access logs into structured information that associates temporal, topical, and relevance attributes. This structured representation allows the server to execute query operations more efficiently using indexed columns and cache mechanisms, thereby reducing retrieval time. The use of dwell time and topic confidence as composite relevance indicators enables the server to prioritize resources in a way that would be difficult to perform manually and reduces the processing required in downstream modules.

The server also optimizes communication between the terminal and the server by aggregating activity information into batches and by transmitting only identifiers and compact summaries rather than full content when interacting with the generative AI model. This reduces the volume of data transferred over the network, which in turn reduces communication latency and bandwidth consumption.

The server configures the generative AI model with specific inference parameters and structured prompts that are optimized to produce consistent, topic-focused summaries. By generating prompt sentences that include explicit instructions and structured input information, the server reduces the computational iterations needed to achieve a usable summary, thereby improving processing efficiency. Moreover, the server's use of precomputed feature vectors and topic labels allows it to bypass repeated heavy analysis on the same content, further reducing computational load.

Unlike human-based summarization or simple rule-based aggregation, the server combines multiple algorithmic components—natural language processing, feature extraction, topic classification, and transformer-based generative modeling—in a non-conventional pipeline that is tailored to the structure of user activity data. The server applies machine learning-based topic classification and relevance scoring to select and shape the input for the generative AI model. This combination of specific data structures, selection rules, and model configuration results in higher accuracy of topic assignments and more coherent summaries than simple keyword counting or manual rule systems.

The server's control of the generative AI model is not limited to a generic “generate text” instruction. Instead, the server supplies carefully constructed prompt sentences and structured auxiliary data that constrain the model's behavior to specific technical tasks, such as retrospective summarization over a date range or topic-focused history generation. This controlled interaction with the model yields predictable, reproducible behavior that is optimized for the constrained domain of user activity histories.

In alternative embodiments, the server may use different storage architectures such as document-oriented databases or key-value stores, or may employ different topic modeling techniques such as clustering over embedding spaces or probabilistic topic models. The terminal may implement the extension function as a native system service that records network requests issued by applications other than a browser. The generative AI model may be hosted locally on the server hardware or accessed as a remote model via an external service. The same overall data structures—activity information, structured information, input information, and prompt sentences—may be retained while changing the underlying implementation technologies.

Another embodiment may adjust the feature extraction method by using contextual embeddings from language models and computing similarity scores between documents and topic prototypes. The server may maintain topic prototype vectors and update them over time using incremental learning, which leads to improved adaptability to evolving user interests. In still another embodiment, the server may apply compression algorithms to store vector representations in a reduced-dimensional space, thereby lowering memory usage while maintaining classification accuracy.

By structuring activity information in a machine-optimized format, by applying specific natural language processing techniques and topic classification algorithms, and by constructing and supplying domain-specific prompt sentences to a generative AI model, the server achieves technical effects including improved processing speed, reduced memory and network usage, higher accuracy of topic assignments, and enhanced stability of generated summaries. These effects arise from the cooperation of the server, the terminal, and the generative AI model in a specific architecture and processing pipeline, rather than from a mere automation of human summarization tasks.

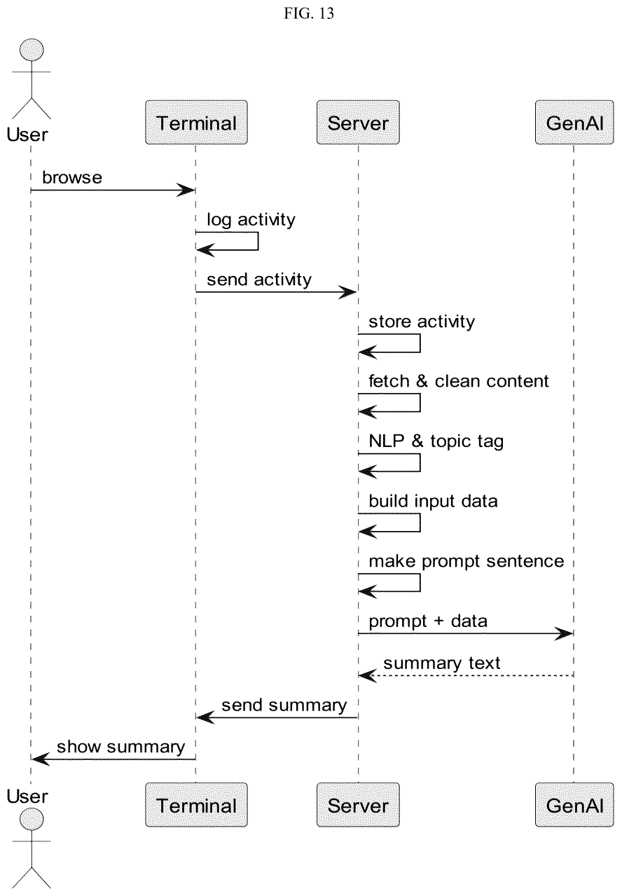

The following describes the processing flow using FIG. 13.

### Step 1:

The terminal detects user actions related to access of information resources.

The terminal receives, as input, user interface events from an application such as a browser (for example, page load events, tab focus events, and tab close events).

The terminal performs data processing by extracting, from each event, a resource identifier, a timestamp, and a session identifier, and by computing dwell time as a difference between a start timestamp and an end timestamp.

The terminal outputs activity information records that include at least a user identifier, a device identifier, a resource identifier, a start time, an end time, and a dwell time value, and stores these records in a local buffer or local database.

### Step 2:

The terminal transmits the buffered activity information to the server.

The terminal receives, as input, a set of locally stored activity information records that have not yet been transmitted.

The terminal performs data processing by grouping multiple records into a batch, serializing the batch into a structured message, and attaching authentication data and a sequence number.

The terminal outputs a network request message containing the batch of activity information and sends it to the server via the communication network using a secure protocol.

### Step 3:

The server receives and validates the transmitted activity information.

The server receives, as input, the network request message containing the batch of activity information from the terminal.

The server performs data processing by parsing the structured message, checking required fields for each record, normalizing timestamps into a standard format, and rejecting or marking invalid records.

The server outputs validated activity records and stores them in a persistent storage structure such as a relational table with columns for user identifier, resource identifier, start time, end time, dwell time, and record identifier.

### Step 4:

The server retrieves content information for information resources referenced in the activity records.

The server receives, as input, a list of resource identifiers from the validated activity records that do not yet have associated content information.

The server performs data processing by issuing network requests for each resource identifier, receiving content data such as markup documents, and checking response codes and content types to filter out errors and unsupported formats.

The server outputs raw content records that associate each resource identifier with the received content data and stores these records in a content storage structure.

### Step 5:

The server cleans and normalizes the raw content data.

The server receives, as input, raw content records including markup-based documents for each accessed information resource.

The server performs data processing by removing non-content elements such as scripts and navigation menus, extracting main body text and titles, normalizing character encodings, and removing extraneous whitespace and markup tags.

The server outputs cleaned content records, each including title information, main text content, and optional metadata, and stores these records in association with the corresponding resource identifiers.

### Step 6:

The server executes natural language processing on the cleaned content to derive topic information.

The server receives, as input, cleaned content records containing title text and main body text.

The server performs data processing by tokenizing the text into words and sentences, applying part-of-speech tagging, lemmatizing tokens, removing stopwords, and generating feature vectors using methods such as term frequency-inverse document frequency or contextual embeddings.

The server outputs topic information for each content record, including one or more topic labels and confidence scores, and stores the topic information in association with the corresponding activity records as structured information.

### Step 7:

The server aggregates activity information and topic information into structured information for each user.

The server receives, as input, validated activity records and topic information records linked by resource identifiers.

The server performs data processing by joining activity records with their corresponding topic labels, grouping records by user identifier, and constructing composite records that include user identifiers, temporal information, dwell time values, resource identifiers, titles, and topic labels.

The server outputs structured information entries for each user and each resource, and persists these entries in a storage device using an indexed schema optimized for topic-based and time-based queries.

### Step 8:

The server selects relevant information resources for a predetermined topic or period.

The server receives, as input, structured information entries together with a selection condition such as a topic label and/or a date range.

The server performs data processing by filtering the entries according to the specified topic label and time range, computing relevance scores that combine dwell time, recency, and topic confidence, and sorting the entries by the relevance scores.

The server outputs a ranked list of selected resources for the user, each including title information, temporal data, topic labels, and relevance scores.

### Step 9:

The server generates summary information and relevance indicator information for the selected resources.

The server receives, as input, the ranked list of selected resources for a specific topic or period.

The server performs data processing by extracting key sentences or phrases from each content record using scoring functions over the feature vectors, and by truncating or combining these key elements into concise summaries.

The server outputs, for each selected resource, summary information and refined relevance indicator information, and augments the ranked list with these new data fields to form input information candidates.

### Step 10:

The server constructs input information for a generative AI model.

The server receives, as input, the list of selected resources augmented with summary information and relevance indicator information.

The server performs data processing by transforming each resource entry into a uniform representation that includes title information, short summary text, temporal information, resource identifiers, and numerical relevance scores, and by packaging multiple entries into a single structured set ordered by relevance.

The server outputs input information that encapsulates the topic-focused and period-focused representation of the user's activity history.

### Step 11:

The Server composes a prompt sentence for the generative AI model based on the input information.

The server receives, as input, the input information and configuration parameters such as desired summary length, style, and focus (for example, topic-based or retrospective).

The server performs data processing by filling a template with topic names, date ranges, and instructions, and by embedding titles, dates, and summary snippets into a coherent natural language instruction.

The server outputs a prompt sentence, such as:
“You are a generative AI model that summarizes user browsing history. The user has recently read the following news articles about environmental issues. Using the titles and excerpts below, write a clear, 800-word summary article that explains the main developments in climate policy and renewable energy. Focus on what has changed recently and why it matters. Articles: [list of titles, dates, and short excerpts].”

### Step 12:

The server submits the prompt sentence and the input information to the generative AI model and obtains generated text information.

The server receives, as input, the prompt sentence and the input information constructed from the selected resources.

The server performs data processing by encoding the prompt sentence and embedded information as token sequences according to the tokenization scheme required by the generative AI model, setting inference parameters such as maximum output length and sampling strategy, and executing the model to predict successive output tokens.

The server outputs generated text information that represents a user activity history or topic-specific summary content, and stores this generated text in association with the corresponding user and selection conditions.

### Step 13:

The server prepares output information for delivery to the terminal.

The server receives, as input, the generated text information together with metadata such as topic label, date range, and identifiers of the underlying resources.

The server performs data processing by formatting the generated text into sections, attaching resource identifiers as references or links, and constructing a response structure that associates the summary with the relevant user and topic.

The server outputs output information containing the formatted generated text and reference data, and sends this information to the terminal via the communication network.

### Step 14:

The terminal displays the output information to the user and collects optional feedback.

The terminal receives, as input, the output information containing the generated text and associated metadata from the server.

The terminal performs data processing by rendering the generated text on a display device, formatting headings and paragraphs, and generating interactive elements such as buttons or links that correspond to the referenced resources.

The terminal outputs a visual presentation of the summary to the user and, if the user provides input such as ratings or comments, generates feedback records and stores or transmits the feedback as additional data for use by the server.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional activity-log and recommendation systems generally treat collected user behavior data as a static record that is filtered or ranked with fixed algorithms. Such systems typically: (i) log raw events in storage, (ii) apply pre-defined heuristics or simple models, and (iii) render fixed-format summaries or recommendations on a terminal. Because the transformation pipeline from raw behavior data to user-facing content is rigid and narrowly parameterized, several computer-technical problems arise.

First, conventional systems lack a dynamic and expressive interface between the behavior data stored in computing resources and the content-generation logic executed by computing resources. Static query templates and fixed reporting logic cannot fully exploit fine-grained life log data or context. As a result, when a user wishes to review a particular time span or topic, or when highly personalized visual content is desired, the underlying processor must execute ad hoc queries and complex application code, leading to increased processing overhead, code complexity, and latency.

Second, conventional architectures do not systematically use structured prompt sentences as a machine-interpretable abstraction layer between preprocessed behavior data and a generative model executed by a processor. Without a standardized prompt-generation mechanism tied to structured life log data and interest profiles, any integration with a generative model is fragile, non-reusable, and difficult to optimize. The processor is required to execute monolithic application logic to compose outputs, which hinders scalability and makes it difficult to adapt the system to new content types or new time ranges without significant code modification.

Third, existing systems are not designed to improve the internal operation of computing components by tightly coupling: (i) multi-stage preprocessing of behavior data (time-series structuring, normalization, topic classification, emotion estimation) with (ii) automatic prompt construction and (iii) generative-model invocation and post-processing. In many architectures, each of these stages is implemented in isolation. Data models are not aligned, and feedback loops from generated content and user reactions back into the behavior-analysis pipeline are weak or missing. This results in inefficient memory access patterns, redundant computations, and non-optimal use of processing resources for retrieval, summarization, and content generation.

Fourth, when a user wishes to retrospectively review activities for arbitrary dates or periods, or to obtain a synthesized “story” of a past interval, conventional systems rely on direct database queries and fixed templates. The processor must execute multiple joins and formatting routines for every request, which increases CPU load and response time. There is no generic mechanism by which the processor can translate an arbitrary temporal or topical query into a machine-understandable instruction for a generative model, thereby improving the flexibility and efficiency of the computer system itself.

Accordingly, there is a need for a computer-implemented technique that improves the functioning of the server and related information processing apparatus by: (i) structuring heterogeneous behavior data into life log data suitable for machine processing, (ii) generating machine-readable prompt sentences derived from that structured data and user profiles, and (iii) using a generative model as a programmable content-generation engine for activity histories, summaries, and personalized visual content. By tightly integrating these elements, the overall system can reduce application-layer complexity, improve scalability and responsiveness, and provide richer and more adaptive outputs while using computing resources more efficiently.

The specific processing by the specific processing unit 290 of the data processing device 12 in Application Example 2 is realized by the following means.

The present invention provides a server comprising a processor and a storage resource, the processor being configured to acquire, via an information processing apparatus and a communication resource, behavior data relating to online and offline activities of a user, to store the behavior data as time-series life log data in the storage resource, to preprocess the life log data by performing time-series formatting, normalization, aggregation, topic classification, phrase extraction, and emotion estimation so as to generate structured life log data and feature information indicating interests and preferences of the user, to construct, on the basis of the structured life log data and the feature information, a prompt sentence that encodes an instruction to a generative artificial intelligence model to generate at least one of an activity history, summary information, and personalized visual information, to input the prompt sentence to the generative artificial intelligence model and obtain model output as textual information or visual information, to store the obtained information in association with the user as history information in the storage resource, and to distribute, to a user terminal, display data including review information for a designated time range or subject and personalized entertainment content on the basis of the stored history information. This enables the computing system to transform raw heterogeneous behavior data into structured prompts for a generative model in a standardized and reusable manner, thereby improving the internal operation of the server by reducing application-level complexity, optimizing data flows between storage and processing components, and providing flexible, on-demand generation of personalized activity summaries and visual content with lower latency and improved scalability.

The term “system” refers to a combination of hardware components and software components that operate together to perform data acquisition, processing, storage, model interaction, and data distribution functions.

The term “processor” refers to a hardware computation unit, such as a central processing unit or an execution core, that executes instructions to perform data processing, analysis, prompt construction, and communication control.

The term “information processing apparatus” refers to an electronic device, such as a client device or terminal, that executes software for capturing user behavior, including applications, browser components, and tracking modules.

The term “user” refers to an individual whose online or offline behavior is recorded, analyzed, and used as a basis for generating activity histories, summaries, or personalized content.

The term “behavior data” refers to digital records representing actions of the user, including at least browsing operations, search operations, response operations, and movements or interactions in a physical environment.

The term “online behavior” refers to user actions performed through a communication network, including accessing network resources, submitting queries, viewing content, and interacting with network-based applications.

The term “offline behavior” refers to user actions that occur in a physical environment and are detected by local sensors or devices, including location changes, object interactions, and in-facility movements.

The term “tracking function” refers to a software or hardware module that detects and records user actions on the information processing apparatus, such as a browser extension, application plug-in, or monitoring agent.

The term “detection function” refers to a software or hardware module that senses user activities in a real-world environment, using sensors such as cameras, motion sensors, or location sensors, and converts them into digital behavior data.

The term “behavior records” refers to structured or semi-structured entries that store captured behavior data with associated metadata, including timestamps, identifiers, and context attributes.

The term “communication unit” refers to a hardware or software interface that transmits and receives data between devices or components over a communication network using a communication protocol.

The term “storage device” refers to a memory resource, such as a database system or non-volatile storage medium, that persistently stores life log data, feature information, history information, and generated content.

The term “time-series life log data” refers to a sequence of behavior records ordered by time, representing the chronological activities of a user in a format suitable for time-based analysis.

The term “data processing program” refers to executable instructions that perform operations such as time-series formatting, normalization, aggregation, and structuring of behavior data.

The term “time-series formatting” refers to the process of organizing behavior records by time, aligning timestamps, and establishing temporal relationships among events.

The term “normalization” refers to data transformation operations that convert heterogeneous values or formats into standardized representations suitable for consistent processing and comparison.

The term “aggregation” refers to the process of combining multiple behavior records into summarized or grouped representations based on criteria such as user, time range, or subject.

The term “structured life log data” refers to life log data that has been processed into a defined schema, including user identifiers, subject labels, temporal segments, and derived attributes.

The term “subject” refers to a logical topic, category, or theme associated with one or more behavior records or content items, such as a particular field of interest or activity type.

The term “natural language processing program” refers to software that analyzes and processes textual data, including tokenization, part-of-speech tagging, entity extraction, topic analysis, and similar language-related operations.

The term “machine learning program” refers to software that implements statistical or learning-based models to infer patterns, classifications, or predictions from data.

The term “topic classification” refers to the operation of assigning one or more subject labels to textual or behavioral data based on its content or context.

The term “phrase extraction” refers to the operation of identifying and extracting meaningful word sequences, such as keywords or key phrases, from textual data.

The term “emotion estimation” refers to the operation of inferring emotional states or affective attributes from user behavior or content using computational models.

The term “feature information” refers to derived numerical or symbolic attributes that represent characteristics of a user's interests, preferences, or behavior patterns.

The term “interests” refers to categories of subjects or activities toward which the user exhibits recurring attention or engagement.

The term “preferences” refers to relative tendencies or priorities of the user among different subjects, content types, or behavior patterns.

The term “generative artificial intelligence model” refers to a computational model that receives input data, such as a prompt sentence, and produces novel textual or visual output that is not limited to direct retrieval of existing records.

The term “prompt sentence” refers to a machine-readable instruction expressed in natural language that encodes a request to the generative artificial intelligence model to produce a specified type of output based on provided context.

The term “activity history” refers to a generated textual or structured representation that narrates or summarizes past behavior of the user over a time range or subject area.

The term “summary information” refers to generated textual content that condenses and abstracts details of life log data into a concise explanation of key events or topics.

The term “personalized visual information” refers to images, video content, or other visual representations that are generated or composed based on life log data and feature information of a specific user.

The term “textual information” refers to generated content in the form of natural-language text, including narratives, summaries, reports, or messages.

The term “visual information” refers to generated or processed content in the form of images, video sequences, or graphical elements.

The term “history information” refers to data stored in the storage device that associates generated textual or visual information with a particular user and time context.

The term “user terminal” refers to an endpoint device operated by the user, such as a portable computing device, that receives and displays information distributed by the server.

The term “display data” refers to information formatted for presentation on a user terminal, including layout metadata and content to be rendered on a user interface.

The term “review information” refers to data that allows a user to retrospectively examine past activities, including summaries, timelines, and extracted highlights for specific time ranges or subjects.

The term “personalized entertainment content” refers to generated or selected content, including media items and narratives, that is tailored to the individual user's interests and preferences as determined from behavior data and feature information.

The term “extension function” refers to a software component integrated with an application environment, such as a plug-in or add-on, that extends the functionality of the information processing apparatus to capture and report behavior data.

The term “browsing operations” refers to user actions related to viewing and navigating content, including loading pages, following links, and scrolling.

The term “search operations” refers to user actions for retrieving information, including entering search queries, submitting them to a search function, and selecting results.

The term “response operations” refers to user actions that provide feedback or interaction with content, including clicks, selections, ratings, comments, or other input events.

The term “date or period designated by the user” refers to a temporal range specified by the user through an interface, including at least a particular day, a set of days, or a start and end time.

The term “summarization or extraction of activity content and related information” refers to generating an output that condenses or selectively presents parts of life log data and associated context for a specified time range or subject.

In one embodiment, a server cooperates with at least one terminal operated by a user and with one or more information processing apparatuses that capture behavior of the user. The server includes a processor, a memory, a storage device such as a relational database system, and a communication interface such as a network adapter. The terminal includes a processor, a memory, a display unit, an input unit, and a communication interface. The information processing apparatus includes a processor and executes tracking software, such as a browser extension or application plug-in, to record user behavior.

The server executes server-side programs implemented, for example, in a programming language such as Python. The server stores time-series life log data and generated content in a structured form using a database management system such as a relational database. The server processes textual data using a natural language processing library such as a tokenization and tagging toolkit and a syntactic parsing toolkit. The server performs machine learning operations using a machine learning framework such as a tensor-based computation library. The server interacts with a generative AI model, such as a transformer-based language model exposing an API endpoint, by transmitting a prompt sentence and receiving generated text or structured output. The server performs image and video processing using an image processing library such as a computer-vision toolkit and may control an external video editing application through a project-file interface.

The terminal executes client-side software implemented, for example, as a web application using a component-based UI framework or as a native mobile application. The terminal runs a tracking function implemented as an extension function within a browser or an operating-system-level monitoring service. The terminal records browsing operations, search operations, and response operations, together with timestamps, resource identifiers, and contextual metadata, in a local data structure such as a ring buffer or event queue. The terminal periodically transmits batches of behavior records to the server using a secure communication protocol, thereby reducing overhead associated with frequent small transmissions.

The user operates the terminal by browsing network resources, entering search queries, interacting with application content, and, in some embodiments, moving within a physical environment where sensors collect location or interaction data. The user may explicitly specify a date or period to be reviewed, a subject of interest, or a preferred type of personalized visual content. The user may also provide ratings or comments as feedback to generated content.

The server organizes collected behavior data in a specific data structure. The server stores each behavior record as a row in a life log table, where fields include at least a user identifier, a timestamp normalized to a unified time standard, a behavior type identifier (for example, browsing, search, response, location change), a resource identifier, a subject label, and a session identifier. The server maintains a separate feature table in which the server stores learned features of each user, including topic weights, recency scores, and emotion scores. The server maintains a history table in which the server associates generated textual or visual information with a user, a time range, and one or more subject labels.

The server processes incoming behavior records in multiple stages. The server first performs time-series formatting by sorting records by normalized timestamp and by grouping records into sessions using heuristics such as time gaps exceeding a predetermined threshold. This grouping reduces the number of random-access operations when the server later aggregates events for a session, thereby improving cache locality and processing speed. The server then performs normalization operations such as converting identifiers to canonical forms, unifying URL formats, and mapping device-specific codes to standardized representations, which enables consistent aggregation and model input preparation.

The server executes a data processing program that computes aggregated statistics from the life log table. The server aggregates, for each user and for each subject, counts of events, total and average dwell times, and recency scores computed using a decay function. The server stores the results as feature vectors in the feature table. By precomputing such features, the server avoids repeated full-table scans and heavy joins at query time, which improves latency and reduces processing load for subsequent content generation.

The server analyzes textual content associated with behavior records using a natural language processing program. The server performs tokenization, part-of-speech tagging, and phrase extraction on page titles, snippets, and article bodies. The server applies topic classification using a trained classifier implemented, for example, as a neural network. In one implementation, the classifier is a feed-forward neural network with an input layer receiving a vectorized representation of text (such as term-frequency or embedding features), one or more hidden layers with rectified linear units, and an output layer with a softmax activation producing probabilities over a set of predefined topics. The server assigns one or more topics to each behavior record based on the output probabilities and stores the topic labels in the life log table.

The server executes an emotion estimation model implemented, for example, as a recurrent neural network or a transformer encoder that receives sequences of user text responses or reaction patterns and outputs emotion scores such as valence and arousal. The server uses a loss function such as cross-entropy or mean-squared error during training, with supervised labels collected from user feedback or annotated datasets. The server updates the parameters of the emotion estimation model using gradient-based optimization methods, such as stochastic gradient descent or an adaptive variant. The server integrates the emotion scores into the feature table as part of the feature vectors for each user.

The server constructs a prompt sentence as a structured natural-language instruction that encodes the server's request to a generative AI model. The server composes the prompt sentence by combining fixed templates with variable segments populated from the structured life log data and feature information. For example, the server may construct a prompt sentence as:

“Analyze the user's recent reading activity about AI technology (articles: ‘Deep Learning Advances’, ‘Applications of Large Language Models in Industry’). Generate a concise 300-word summary of the main themes and suggest three related news topics.”

The server may also construct prompt sentences tailored to retrospective review, such as:

“Using the web-browsing history of user ID 12345 from the past week, generate a chronological activity log that describes the main tasks and topics the user focused on.”

Furthermore, the server may construct prompt sentences for personalized visual content, such as:

“The user is highly interested in AI technology and action movies. Generate a detailed scenario for a 3-minute video that explains a recent AI breakthrough using an action-movie narrative style.”

By constructing prompt sentences from structured data and feature vectors, the server transforms internal data structures into a compact, model-interpretable specification. This transformation reduces the volume of data transmitted to the generative AI model, which reduces communication load and external API processing time. Additionally, by separating data preparation logic from prompt templates, the server can reuse template structures for different users and time ranges, improving maintainability and reducing code duplication.

The generative AI model in one embodiment is a transformer-based neural network that includes multiple self-attention layers. The model receives the prompt sentence as tokenized input and outputs a sequence of tokens representing generated text or structured content. The model has been trained using large-scale text corpora, with a training objective such as next-token prediction or masked-token reconstruction. The training process includes computing a cross-entropy loss between predicted tokens and ground-truth tokens, followed by weight updates using gradient descent. The server does not retrain the model in real time for each user, but the server adapts model behavior through careful design of the prompt sentence and optional use of few-shot examples in the prompt.

The server post-processes model output before storage and presentation. For textual output, the server may detect excessive repetition, truncate outputs exceeding a predetermined length, and remove content outside the requested time range or subject scope. For structured output representing a video scenario, the server parses the output into scene units, each containing scene description, duration, characters, and dialogue. The server maps these scene units into an internal storyboard data structure that the server passes to a video composition module.

The server, in a visual-content-oriented embodiment, generates personalized visual information by controlling a video generation pipeline. The server uses a machine learning program, such as a generative model for images or video, to synthesize visual elements based on the storyboard. The server then uses an image processing library to compose frames, add transitions, overlay text derived from the script, and encode the final output using a video codec. The server may also control an external video editing application by generating a project file that specifies clip ordering, effect parameters, and timing. This control of external software by data-driven storyboards enables automated but technically structured video rendering that would be impractical to perform manually for each user.

The terminal receives display data from the server that includes review information and personalized entertainment content. The terminal renders timelines, summaries, and links on a graphical user interface. The terminal also plays generated video content using a media player component. The terminal records user interactions such as playback completion, pauses, skips, and explicit ratings, and transmits such information back to the server as feedback. By capturing this feedback, the terminal and server create a closed-loop system that allows continuous refinement of user feature vectors.

The server updates user feature vectors using a learning procedure. The server aggregates feedback signals in the feedback table and periodically trains or fine-tunes a prediction model that maps content attributes and user features to feedback values. The server employs a loss function such as mean-squared error or cross-entropy for this prediction task and updates model weights using mini-batch gradient descent. The server then recalculates or adjusts topic weights and interest scores in the feature table, thereby explicitly encoding changes in user preferences. Because subsequent prompt sentences are generated using these updated feature vectors, the system adaptively changes the instructions submitted to the generative AI model. This adaptation results in more relevant content and reduces the need for manual rule maintenance.

The above architecture improves computer technology rather than merely automating a human task. By introducing a structured life log schema, precomputed feature vectors, and a standardized prompt-generation layer between storage and a generative AI model, the server reduces the computational complexity of on-demand summarization and content generation. Query-time processing no longer requires intensive ad hoc joins or full re-analysis of raw logs; instead, the server retrieves preprocessed structures and composes a compact prompt sentence. This design improves processing speed and responsiveness for user queries, particularly for long time spans or large volumes of behavior data.

Furthermore, by aligning data structures and model features, the server reduces memory usage and cache misses. The server accesses compact feature vectors and indices rather than scanning entire raw logs. In addition, by compressing context into prompt sentences, the server reduces communication overhead between components and external services, because raw data is not transmitted to the generative AI model. These technical effects—reduced latency, improved throughput, reduced memory consumption, and lower bandwidth usage—directly improve the functioning of the computer system.

The system also employs specific, non-conventional processing rules that differ from straightforward human workflows. For instance, the server uses time-decay functions when computing recency scores, applies multi-level topic aggregation based on hierarchical taxonomies, and uses emotion scores as weighting factors when selecting content to describe in a summary. The server uses such quantitative rules to decide which events to highlight or omit in the prompt sentence. A human would not ordinarily apply such systematic weighting across a large historical dataset, whereas the server uses these rules to produce consistent, optimized prompts that guide the generative AI model toward efficient use of its capacity. In another embodiment, the server integrates data from physical environments through detection functions implemented on terminals or separate sensors. The server stores physical-location events in the same life log schema, allowing cross-modal summaries that combine online and offline behavior. For example, the server may generate a prompt sentence such as: “Based on the customer's in-store behavior, identify the most interesting product category and generate three personalized promotion messages.”

In this case, the server uses physical movement patterns and dwell times around specific zones to compute interest scores per category and encodes the highest-scoring categories in the prompt sentence. This technique improves device control and resource usage by enabling targeted notifications rather than broadcasting generic promotions to all users. In a further embodiment, the server supports arbitrary temporal queries specified by the user. The user may enter a natural-language instruction such as “Show my activity related to the new marketing strategy last week.” The terminal transmits this instruction to the server. The server translates the instruction into a structured query that filters life log data by subject and time range and then constructs a corresponding prompt sentence, for example:

“Using the activity logs, extract and summarize all actions related to the new marketing strategy between [date1] and [date2].”

The generative AI model returns a narrative summary specialized for the requested interval. Because the server uses precomputed indices and feature tables, the server can rapidly assemble the necessary context and generate the prompt sentence, reducing response time in comparison with a system that would reprocess all raw logs at request time.

Alternative embodiments may employ different model architectures. For topic classification, the server may use a convolutional neural network over word embeddings rather than a feed-forward network. For emotion estimation, the server may use a transformer encoder with multi-head self-attention. For generative modeling, the server may use an encoder-decoder architecture trained for summarization, where the encoder receives a compact representation of selected log entries and the decoder produces a summary. The server may also vary the number of layers, the dimensionality of embeddings, and the choice of optimization algorithms. In each embodiment, however, the server maintains the core structure of (i) life log storage and preprocessing, (ii) feature-vector computation, (iii) prompt sentence generation, and (iv) model invocation with post-processing and storage of results. In yet another embodiment, the server may operate in a distributed environment, where different server nodes perform different stages. One node may specialize in ingesting and normalizing behavior records; another node may run NLP and feature extraction; a third node may manage prompt generation and generative model interaction. The nodes share data through distributed storage structures. This distribution allows horizontal scaling and improved fault tolerance while preserving the described technical advantages of standardized prompt-based generation over preprocessed life logs.

Through these embodiments, the server, the terminal, and the user cooperate to realize a system in which structured life log data, feature vectors, and prompt sentences are used to control a generative AI model in a technically specific manner. The system thereby improves the internal operation of computer components, provides efficient and scalable generation of activity histories, summaries, and personalized visual content, and offers technical benefits such as reduced processing time, improved accuracy of content selection, and optimized resource usage in communication and storage.

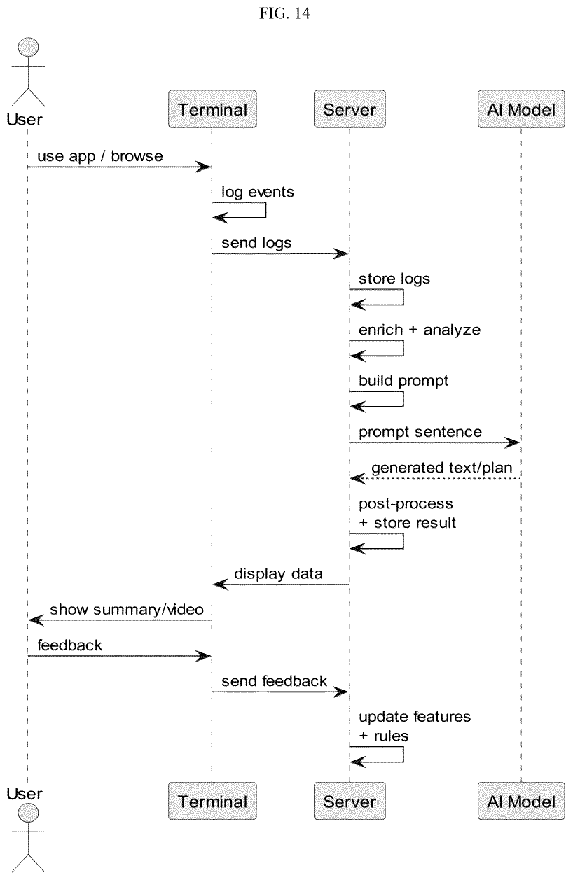

The following describes the processing flow using FIG. 14.

### Step 1:

User Generates Behavior Data.

User operates the terminal by performing online and offline activities such as browsing network resources, entering search queries, clicking links, submitting forms, watching videos, and moving through physical spaces where sensors are present. The input to this step is the user's natural actions on applications, browsers, and physical devices. The output of this step is raw interaction signals such as key presses, touch events, URL requests, and sensor readings that are observable by the terminal and an information processing apparatus.

### Step 2:

Terminal captures and buffers behavior records.

Terminal executes a tracking function such as a browser extension or application plug-in that intercepts events generated in Step 1. The input to this step is the raw interaction signals and sensor outputs. Terminal converts each event into a behavior record containing at least a timestamp, a user identifier, an event type, a resource identifier (for example, a URL or content ID), and optional context such as viewport position or device type. Terminal stores these behavior records in a local buffer or queue structure. The output of this step is a batch of buffered behavior records ready for transmission.

### Step 3:

Terminal transmits behavior records to the server.

Terminal periodically checks the buffer size or a timer and determines whether to send a batch of behavior records. The input to this step is the locally buffered set of behavior records from Step 2. Terminal serializes the records into a message format such as JSON, opens a secure communication channel using a protocol such as HTTPS, and sends the serialized batch to a server endpoint. The output of this step is a transmitted payload that contains a structured list of behavior records received by the server.

### Step 4:

Server receives and validates behavior records.

Server listens on a network interface and accepts incoming connections from terminals. The input to this step is the transmitted payload from Step 3. Server deserializes the payload, checks that required fields such as timestamps and user identifiers are present, filters out malformed or duplicate records, and assigns internal identifiers where necessary. Server then prepares a normalized in-memory representation of the behavior records. The output of this step is a validated array of behavior records suitable for insertion into persistent storage.

### Step 5:

Server Stores Life Log Entries in a Database.

Server connects to a storage device such as a relational database and inserts the validated behavior records into a life log table. The input to this step is the normalized behavior records from Step 4. Server performs timestamp normalization (for example, converting to a standardized time zone), generates session identifiers based on time gaps between events, and writes each record with fields including user ID, timestamp, event type, resource identifier, subject placeholder, and session ID. The output of this step is persistent time-series life log data stored in the database.

### Step 6:

Server enriches life log entries with content and metadata.

Server identifies behavior records that reference external resources such as web pages or documents. The input to this step is the stored life log entries from Step 5. Server uses an HTTP client to retrieve associated page titles, snippets, and full texts, then parses the retrieved content. Server attaches this information to the corresponding life log entries and may also compute additional metadata such as content length or language. The output of this step is enriched life log data where each record may include textual content fields.

### Step 7:

Server performs time-series formatting and aggregation.

Server groups enriched life log entries by user and session. The input to this step is the enriched life log data from Step 6. Server sorts entries by timestamp, computes dwell time between consecutive events, and aggregates statistics such as total session duration and number of events per session. Server stores these aggregates in derived tables or summary rows. The output of this step is structured life log data and session-level summaries prepared for analysis.

### Step 8:

Server executes natural language processing on textual content.

Server selects textual fields such as titles and body text from enriched records. The input to this step is the structured life log data and associated text from Step 7. Server runs a natural language processing program that tokenizes text, removes stop words, applies part-of-speech tagging, and extracts key phrases. Server also vectorizes the text into feature representations such as term-frequency vectors or embeddings. The output of this step is a set of NLP annotations and vectorized features linked to the original life log entries.

### Step 9:

Server classifies topics and estimates emotions.

Server applies one or more trained machine learning models to the NLP features and behavioral patterns. The input to this step is the NLP annotations and vectorized features from Step 8, along with behavioral metrics such as dwell time. Server uses a topic classifier (for example, a neural network) to assign subject labels and a separate model (for example, a recurrent or attention-based network) to compute emotion scores, such as positive or negative sentiment. Server writes the resulting subject labels and emotion scores back to the life log table and to feature tables. The output of this step is life log data annotated with topics and emotional attributes.

### Step 10:

Server Computes User Feature Vectors.

Server aggregates annotated life log data for each user. The input to this step is the topic-labeled and emotion-scored entries from Step 9. Server calculates, for each user and each topic, metrics such as event count, total dwell time, and a recency-weighted score using a decay function. Server integrates emotion scores to adjust weights, increasing the importance of topics associated with positive reactions. Server stores these metrics as feature vectors in a user feature table. The output of this step is a set of user feature vectors representing interests and preferences.

### Step 11:

Server selects relevant context for a target request.

Server receives a request, either explicitly from the user or implicitly from a scheduled job, to create an activity history, summary, or personalized visual content. The input to this step is the user identifier, optional time range or subject, life log data, and user feature vectors from Step 10. Server filters the life log to the specified time span and subjects, ranks events using feature weights and recency, and selects a subset of events as context. The output of this step is a context set consisting of scored log entries and associated features.

### Step 12:

Server constructs a prompt sentence for a generative AI model.

Server converts the context set into a structured natural-language instruction. The input to this step is the context set from Step 11 and predefined template rules. Server fills template segments with user-specific details, such as topic names, article titles, and time boundaries, and encodes requested output type and constraints (for example, length or style). For example, server may generate a prompt sentence such as:

“Using the web-browsing history of user ID 12345 from the past week, generate a chronological activity log that describes the main tasks and topics the user focused on.”

The output of this step is a prompt sentence suitable for input to a generative AI model.

### Step 13:

Server sends the prompt sentence to the generative AI model and receives output.

Server establishes a connection to a generative AI model endpoint. The input to this step is the prompt sentence from Step 12 and optional model parameters such as maximum output length. Server tokenizes the prompt, transmits the token sequence to the model, and waits for the model to generate an output token sequence. Server decodes the tokens into human-readable text or structured content and checks for termination conditions. The output of this step is model-generated textual information and, in some embodiments, scenario or structure descriptions for visual content.

### Step 14:

Server post-processes generated textual information.

Server analyzes the generated output to enforce constraints and improve coherence. The input to this step is the raw generated text from Step 13. Server trims segments that exceed length limits, removes repeated sentences, and ensures that the text remains within the requested time range or subject scope. Server may also segment the text into paragraphs or items for easier display. The output of this step is refined textual information, such as an activity history or summary, ready for storage and presentation.

### Step 15:

Server generates a storyboard for personalized visual content.

Server interprets generated descriptions that include scene structure or narrative elements. The input to this step is the structured or semi-structured output from Step 13 or 14 when a visual scenario has been requested. Server parses the descriptions into a storyboard data structure where each entry represents a scene with fields such as scene ID, duration, location description, characters, and dialogue. Server aligns this storyboard with relevant images or media assets referenced by resource identifiers. The output of this step is a machine-readable storyboard for video generation.

### Step 16:

Server composes visual content using the storyboard.

Server uses a video composition module to create personalized visual information. The input to this step is the storyboard from Step 15 and media resources such as images or clips. Server calls image-processing functions to generate frames or to adapt existing frames, applies transitions between scenes, overlays subtitles derived from dialogue text, and encodes the sequence into a video file with predefined resolution and format. The output of this step is a completed visual content file or stream associated with the user.

### Step 17:

Server stores generated content and updates history information.

Server writes generated textual and visual content to the storage device. The input to this step is the refined textual information from Step 14 and the visual content from Step 16. Server creates entries in a history table that link each piece of content to a user identifier, a time range, subject labels, and content-type metadata. The output of this step is updated history information that can be retrieved for later review or playback.

### Step 18:

Server prepares display data for the terminal.

Server formats the stored history information and generated content into a structure suitable for rendering. The input to this step is history table entries from Step 17 and user request parameters. Server organizes summaries into lists, attaches thumbnails, and generates timelines. Server embeds links or identifiers for visual content and packages these elements into a display-data object. The output of this step is a display-data set that includes review information and personalized entertainment content.

### Step 19:

Terminal receives and renders display data.

Terminal requests and obtains display data from the server. The input to this step is the display-data set from Step 18 transmitted over the communication interface. Terminal parses the data, populates user interface components such as lists, cards, and timelines, and starts playback of visual content using a media player when requested by the user. The output of this step is a graphical and audiovisual presentation of summaries, activity histories, and personalized visual content to the user.

### Step 20:

User reviews content and provides feedback.

User reads the generated summaries, inspects timelines, and watches personalized visual content rendered by the terminal. The input to this step is the displayed information from Step 19. User may interact with control elements such as rating buttons, comment fields, and playback controls to express satisfaction, interest, or disinterest. The output of this step is explicit feedback signals (such as ratings and comments) and implicit behavior signals (such as watch-time and skips) captured by the terminal.

### Step 21:

Terminal transmits feedback data to the server.

Terminal collects feedback events generated in Step 20. The input to this step is the set of feedback signals linked with user identifiers and content identifiers. Terminal formats these signals into records containing fields such as rating value, content ID, timestamp, and optional text. Terminal sends a batch of feedback records to the server via a secure communication channel. The output of this step is a feedback payload made available to the server.

Step 22:

Server updates models and feature vectors using feedback.

Server receives and parses the feedback payload. The input to this step is the batch of feedback records from Step 21 as well as existing user feature vectors. Server aggregates feedback by content and topic, computes loss values for predictive models (for example, comparing predicted satisfaction to actual ratings), and performs weight updates using optimization algorithms. Server then recalculates or adjusts topic weights and interest scores in the user feature vectors. The output of this step is an updated set of feature vectors and, when applicable, updated model parameters.

### Step 23:

Server adjusts future prompt sentences based on updated features.

Server uses the updated feature vectors produced in Step 22. The input to this step is the new feature vectors and the template set for various request types. Server modifies the weighting of topics selected as context, changes emphasis phrases within templates (for example, “focus on action-related aspects” or “emphasize environmental sustainability topics”), and updates parameters such as desired length or detail level. The output of this step is adjusted prompt-sentence generation rules that will be used in subsequent executions of Step 12, enabling more precise and efficient interaction with the generative AI model.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

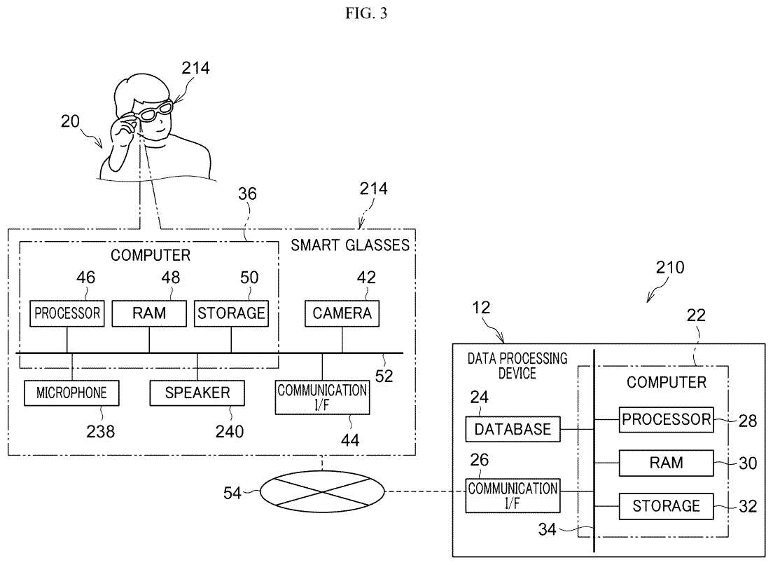

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

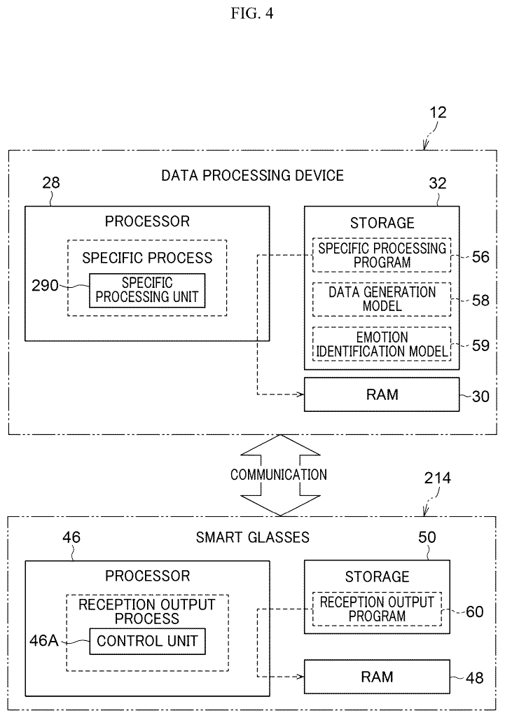

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

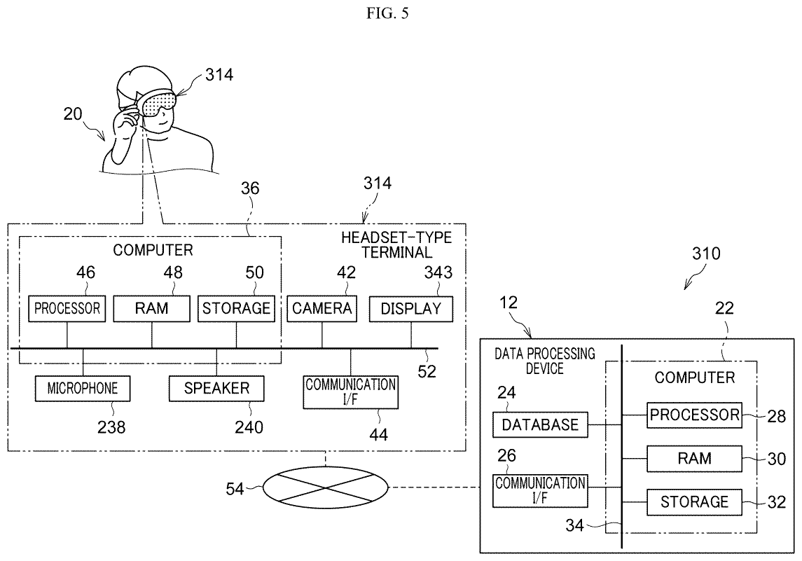

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

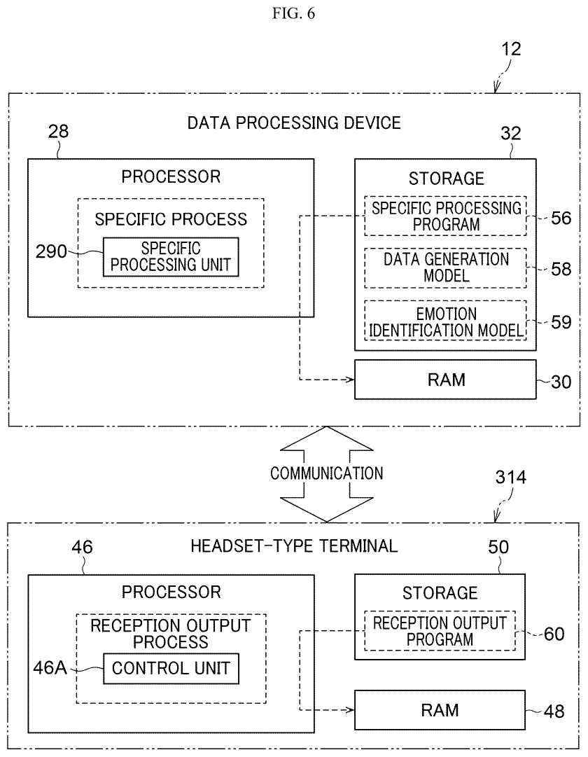

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

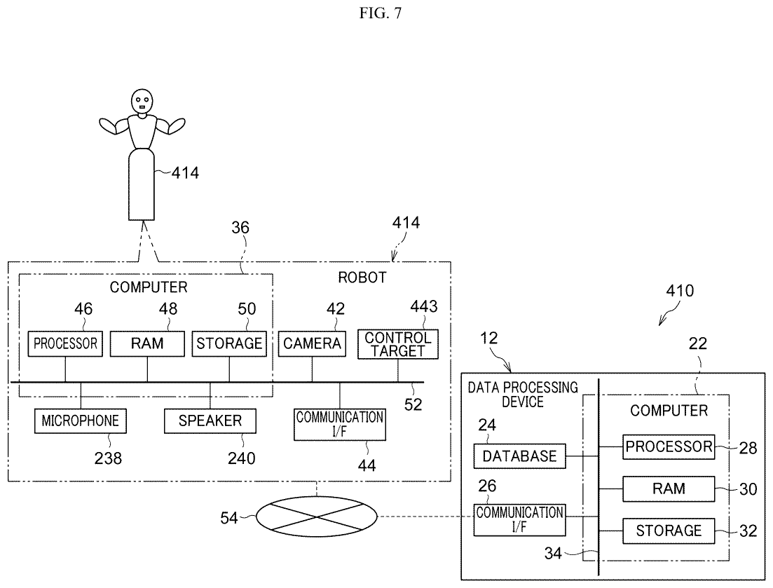

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

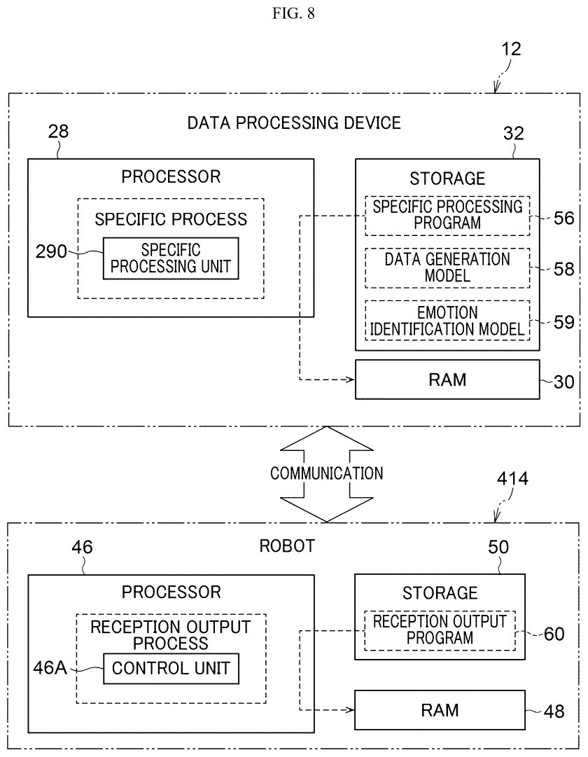

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

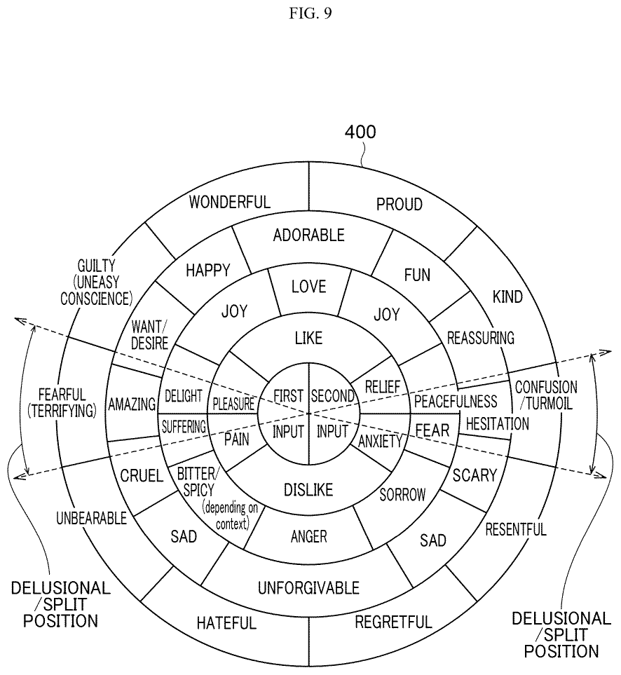

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

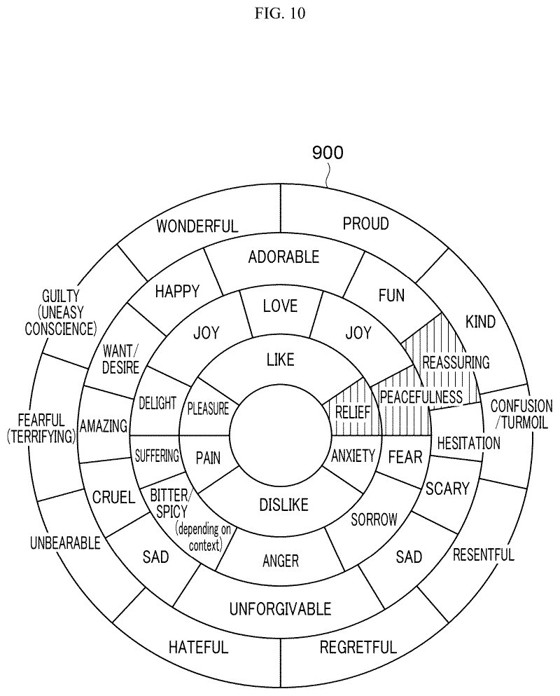

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,
pwherein the processor is configured to
monitor, by using a display control function operating on an information processing
apparatus, browsing operations of a user with respect to an information resource, and acquire identification information and viewing time information relating to the information resource,
structure acquired identification information and viewing time information of the information resource as activity information in association with a time series, and transmit the activity information to a storage function via a communication function so that the activity information is accumulated in the storage function,
generate a prompt sentence based on the activity information accumulated in the storage function, the prompt sentence including at least a part of user identification information, time range information, attribute information of the information resource, and summary instruction information, embed at least a part of the activity information into the prompt sentence, and input the prompt sentence to a generative information processing model so as to instruct the generative information processing model to generate at least one of an activity history of the user and summary information relating to the activity history, and
acquire at least one of the activity history and the summary information output from the generative information processing model, and generate history information in a format capable of being presented to the user based on an acquired result.

### Supplementary 2

The system according to supplementary 1,
wherein the processor is configured to
analyze structural information of the information resource displayed by the display control function by using an acquisition function implemented as an extension function operating on the information processing apparatus, extract from the structural information at least identification information of the information resource, title information, and viewing duration information, and cause an extraction result to be accumulated in the storage function as the activity information through generation of the prompt sentence and input of the prompt sentence to the generative information processing model.

### Supplementary 3

The system according to supplementary 1,
wherein the processor is configured to
include, in the prompt sentence, a condition for extracting activity information corresponding to date information or period information contained in a query sentence in natural language format received from the user, instruct the generative information processing model to extract and organize related information that satisfies the condition, and generate, based on the related information output from the generative information processing model, history information that allows the user to review activity content in a specific date or period.

### Application Example 1

### Supplementary 1

A system comprising a processor,
wherein the processor is configured to track activities of a user by using an information processing apparatus and acquire behavior information including access information to information resources on a network and information generated by the user with respect to the information resources,
wherein the processor is configured to acquire structured content information from the information resources on the network based on the behavior information and generate a behavior log including the behavior information and the content information,
wherein the processor is configured to transmit the behavior log to a data management apparatus and store the behavior log in a data storage area of the data management apparatus,
wherein the processor is configured to obtain the behavior log from the data storage area, preprocess character information included in the behavior log by using a data processing program, convert the character information into feature values, and generate a plurality of cluster information items corresponding to interests of the user based on the feature values, wherein the processor is configured to select or extract information on a plurality of candidate information resources to be provided to the user as information provision targets based on the cluster information and the behavior log, and generate text data including metadata relating to the plurality of candidate information resources,
wherein the processor is configured to generate a prompt sentence for causing a generative information processing model to generate recommendation information for each user based on the cluster information and the text data, and input the prompt sentence to the generative information processing model, and
wherein the processor is configured to identify information resources to be presented to the user based on the recommendation information output from the generative information processing model and generate presentation data for outputting an identification result of the information resources to a display apparatus.

### Supplementary 2

The system according to supplementary 1,
wherein the processor is configured to acquire the behavior log and the cluster information by using an extension program operating on the information processing apparatus, automatically generate the prompt sentence including summary information indicating the interests of the user, identification information and metadata relating to the plurality of candidate information resources, and a description for instructing the generative information processing model to select or rank the candidate information resources, and input the prompt sentence to the generative information processing model.

### Supplementary 3

The system according to supplementary 1,
wherein the processor is configured to generate the prompt sentence based on designation information indicating a specific date or period and the behavior log, extract the behavior log corresponding to the specific date or period based on the designation information, and generate the prompt sentence including a description for instructing the generative information processing model to generate a summary of an activity history within the specific date or period and extract information related to the interests of the user based on the extracted behavior log, and input the prompt sentence to the generative information processing model.

### EXAMPLE 2

### Supplementary 1

A system comprising a processor,
wherein the processor is configured to
track user actions to acquire access information relating to information resources and to generate activity information including identification information, time information, and dwell time information contained in the access information,
obtain, via a communication network, content information from the information resources corresponding to the activity information, execute natural language processing on the content information to extract topic information, and store, in a storage device, structured information in which the topic information is associated with the activity information,
select, from the structured information, a plurality of information resources associated with a predetermined topic, and generate input information including title information, summary information, and relevance indicator information of the plurality of information resources,
create, based on the input information, a prompt sentence for instructing a generative AI model to generate a user activity history or topic-specific summary content, input the prompt sentence and the input information into the generative AI model, and obtain text information generated by the generative AI model, and
provide the generated text information, as output information, to a user terminal device.

### Supplementary 2

The system according to supplementary 1,
wherein the processor is configured to
acquire the access information using an extension function or an application function operating on the user terminal device, and control the extension function or the application function to transmit the activity information to the storage device.

### Supplementary 3

The system according to supplementary 1,
wherein the processor is configured to
extract activity information corresponding to a date or a period specified by the user, based on date information or period information included in the structured information, create a prompt sentence for instructing the generative AI model to generate related information or retrospective information concerning the specified date or period using the extracted activity information, and input the prompt sentence into the generative AI model.

### Application Example 2

### Supplementary 1

A system comprising a processor and an information processing apparatus configured to acquire behavior of a user,
wherein the processor is configured to
acquire data relating to online or offline behavior of the user by using a tracking function operating on the information processing apparatus and a detection function operating in a real-world environment, and to collect the data as behavior records,
transmit the collected behavior records to a storage device via a communication unit and store the behavior records in the storage device as time-series life log data,
perform, on the stored life log data, time-series formatting, normalization, and aggregation by using a data processing program so as to structure the life log data on a per-user basis and on a per-subject basis,
analyze the structured life log data by using a natural language processing program and a machine learning program to perform topic classification, phrase extraction, and emotion estimation, and to generate feature information indicating interests and preferences of the user,
construct, on the basis of the feature information and the life log data, a prompt sentence for instructing a generative artificial intelligence model to generate at least one of an activity history, summary information, and personalized visual information, and input the prompt sentence to the generative artificial intelligence model,
obtain textual information or visual information output from the generative artificial intelligence model and store the obtained information in association with the user as history information in the storage device, and
distribute, to a user terminal, display data including review information in accordance with a time range or a subject and personalized entertainment content, on the basis of the stored history information.

### Supplementary 2

The system according to supplementary 1,
wherein the processor is configured to
acquire behavior data including browsing operations, search operations, and response operations of the user by using an extension function operating on the information processing apparatus, generate, from the acquired behavior data, a prompt sentence for instructing the generative artificial intelligence model to generate the activity history, and input the prompt sentence to the generative artificial intelligence model.

### Supplementary 3

The system according to supplementary 1,
wherein the processor is configured to
extract, from the stored life log data and the history information, a portion corresponding to a date or a period designated by the user, generate, on the basis of the extracted portion, a prompt sentence for instructing the generative artificial intelligence model to perform summarization or extraction of activity content and related information for the designated date or period, and input the prompt sentence to the generative artificial intelligence model.

What is claimed is:

1. A system comprising:
circuitry configured to:
acquire, via a communication interface coupled to a packet-switched network, interaction event data from a terminal device, the interaction event data representing operations performed by a user on an information processing apparatus;
store the interaction event data in an information storage device by associating each interaction event with a timestamp and a resource identifier;
execute a feature extraction operation on the interaction event data to generate feature vectors representing characteristics of the interaction events, and classify the feature vectors into topic categories by inputting the feature vectors into a neural network configured to output probability values over a plurality of topic labels;
construct an instruction sequence comprising a temporal range parameter, the topic categories, and a subset of the interaction event data selected based on the temporal range parameter, and input the instruction sequence into a generative neural network model comprising a transformer-based architecture to generate temporal summary data describing the interaction events within the temporal range; and
transmit the temporal summary data to the terminal device via the communication interface.

2. The system according to claim 1, wherein the circuitry is further configured to:
normalize the interaction event data by converting resource identifiers to a canonical format, removing duplicate entries within a threshold time window, and standardizing encoding of text content associated with the interaction events.

3. The system according to claim 2, wherein the circuitry is further configured to:
extract content information from information resources corresponding to the resource identifiers via the packet-switched network, and generate structured records each comprising the resource identifier, the timestamp, a dwell time value, and extracted content features.

4. The system according to claim 3, wherein the circuitry is further configured to:
compute a relevance score for each structured record based on a weighted combination of the dwell time value and a topic confidence value derived from the neural network, and select a subset of the structured records exceeding a relevance threshold for inclusion in the instruction sequence.

5. The system according to claim 4, wherein the circuitry is further configured to:
group the selected structured records by date and by topic category to produce a hierarchical data structure, and include the hierarchical data structure in the instruction sequence to instruct the generative neural network model to generate the temporal summary data in a chronological and topic-organized format.

6. The system according to claim 1, wherein the circuitry is further configured to:
acquire the interaction event data by executing an extension module operating within an application environment on the information processing apparatus, the extension module monitoring navigation events, input operations, and resource access events, and transmitting the interaction event data to the circuitry via the communication interface.

7. The system according to claim 6, wherein the extension module is further configured to:
capture a page content snapshot for each navigation event, extract text content and metadata from the page content snapshot, and transmit the text content and metadata as part of the interaction event data.

8. The system according to claim 1, wherein the circuitry is further configured to:
receive a query input from the terminal device specifying a date or a temporal period, retrieve interaction event data corresponding to the specified date or temporal period from the information storage device, construct a second instruction sequence instructing the generative neural network model to generate retrospective summary data based on the retrieved interaction event data, and transmit the retrospective summary data to the terminal device.

9. The system according to claim 8, wherein the second instruction sequence further comprises:
an instruction to identify recurring themes across the interaction events within the specified temporal period and to generate a trend analysis segment within the retrospective summary data.

10. The system according to claim 1, wherein the generative neural network model comprises:
an embedding layer configured to convert tokens of the instruction sequence into embedding vectors, a positional encoding module configured to add positional information to the embedding vectors, a plurality of transformer layers each comprising a multi-head self-attention mechanism and a feed-forward sublayer with layer normalization, and a decoding stage configured to generate a probability distribution over a vocabulary and select output tokens using a sampling strategy.

11. The system according to claim 10, wherein the circuitry is further configured to:
set inference parameters for the generative neural network model comprising a temperature value, a maximum token count, and a sampling strategy selection, and adjust the inference parameters based on a length of the instruction sequence and a number of interaction events included therein.

12. The system according to claim 1, wherein the circuitry is further configured to:
compute embedding vectors for the interaction event data, calculate similarity values between the embedding vectors using a distance metric, group the interaction event data into clusters based on the similarity values, and generate cluster information comprising a cluster identifier, a representative topic label, and a count of interaction events for each cluster.

13. The system according to claim 12, wherein the circuitry is further configured to:
include the cluster information in the instruction sequence to instruct the generative neural network model to generate the temporal summary data organized by cluster, with each cluster represented as a thematic segment within the temporal summary data.

14. The system according to claim 1, wherein the circuitry is further configured to:
maintain a user profile data structure storing preference parameters comprising a summarization level parameter, a grouping criterion parameter, and a focus topic parameter, and modify the instruction sequence based on the preference parameters to control granularity and content focus of the temporal summary data.

15. The system according to claim 14, wherein the circuitry is further configured to:
update the preference parameters based on feedback input received from the terminal device, the feedback input comprising a rating value or an adjustment instruction for modifying subsequent temporal summary data generation.

16. The system according to claim 1, wherein the circuitry is further configured to:
detect a plurality of information processing apparatuses associated with the user, aggregate interaction event data from the plurality of information processing apparatuses into a unified data structure in the information storage device, and include a device identifier with each interaction event to enable device-specific filtering in the instruction sequence.

17. The system according to claim 16, wherein the interaction event data comprises at least one of: web browsing navigation events, application usage events, document editing events, communication events, search query events, or file access events, and the circuitry is further configured to categorize the interaction event data by event type prior to constructing the instruction sequence.

18. A system comprising:
circuitry configured to:
acquire interaction event data from a terminal device via a communication interface, the interaction event data representing user operations on an information processing apparatus, each interaction event associated with a timestamp and a resource identifier;
store the interaction event data in an information storage device, extract content features from information resources corresponding to the resource identifiers, and compute relevance scores based on dwell time values and topic confidence values derived from a classification neural network;
construct an instruction sequence comprising a temporal range parameter and selected interaction event data exceeding a relevance threshold, and input the instruction sequence into a generative neural network model to generate temporal summary data; and
transmit the temporal summary data to the terminal device.

19. The system according to claim 18, wherein the circuitry is further configured to:
receive a query specifying a date or temporal period from the terminal device, retrieve corresponding interaction event data from the information storage device, construct a second instruction sequence instructing the generative neural network model to generate retrospective summary data including trend analysis and recurring theme identification, and transmit the retrospective summary data to the terminal device.

20. A method comprising:
acquiring, by circuitry via a communication interface coupled to a packet-switched network, interaction event data from a terminal device, the interaction event data representing operations performed by a user on an information processing apparatus;
storing the interaction event data in an information storage device by associating each interaction event with a timestamp and a resource identifier;
executing a feature extraction operation on the interaction event data to generate feature vectors representing characteristics of the interaction events, and classifying the feature vectors into topic categories by inputting the feature vectors into a neural network configured to output probability values over a plurality of topic labels;
constructing an instruction sequence comprising a temporal range parameter, the topic categories, and a subset of the interaction event data selected based on the temporal range parameter, and inputting the instruction sequence into a generative neural network model comprising a transformer-based architecture to generate temporal summary data describing the interaction events within the temporal range; and
transmitting the temporal summary data to the terminal device via the communication interface.
